(19) United States
(12) Patent Application Publication
(10) Pub. No.: US 2024/0412230 A1
(43) Pub. Date: Dec. 12, 2024

(54) Product Rights Management Systems and Methods Using Secure Tags and Cryptographic Tokens

(71) Applicant: Intertrust Technologies Corporation, Berkeley, CA (US)

(72) Inventors: Yutaka NAGAO, Minami-Alps (JP); Talal Shamoon, Berkeley, CA (US); Albhy Galuten, Santa Monica, CA (US)

(73) Assignee: Intertrust Technologies Corporation, Berkeley, CA (US)

(21) Appl. No.: 18/736,396

(22) Filed: Jun. 6, 2024

Related U.S. Application Data
(60) Provisional application No. 63/507,439, filed on Jun. 9, 2023.

(51) Int. Cl. G06Q 30/018; H04L 9/08; H04L 9/32

(52) U.S. Cl. CPC G06Q 30/018; H04L 9/0819; H04L 9/3242; G06Q 2220/10

(57) ABSTRACT

Embodiments of the disclosed systems and methods provide for the management of products using secure tags and a token rights management ecosystem. Products may be associated with secure tags and/or digital tokens which may be used in connection with various disclosed management paradigms. Marketplace service and token rights management services are described that facilitate, among other things, registration of products and/or associated secure tags, management of missing, lost, and/or otherwise stolen products, validation of products and/or associated secure tags, identification and/or management of ownership rights of products, and/or the like. In some embodiments, trusted ledger and/or blockchain services may be employed to manage and/or validate digital tokens securely associated with products using secure tags.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### CROSS-REFERENCE TO RELATED APPLICATIONS

This application claims the benefit of priority under 35 U.S.C. § 119 (e) to U.S. Provisional Application No. 63/507,439, filed Jun. 9, 2023, and entitled “Product Rights Management Systems and Methods Using Secure Tags and Cryptographic Tokens,” which is hereby incorporated by reference in its entirety.

### SUMMARY OF THE INVENTION

The present disclosure relates generally to systems and methods for managing products, which may be embodied as physical and/or digital products, and associated rights. More specifically, the present disclosure relates to systems and methods for managing products using secure tags and non-fungible tokens (“NFTs”).

Rights associated with and/or otherwise related to products may be managed in a number of ways. For example, products and/or associated rights may be managed using identification information that may be securely associated with products and/or associated digital assets. In some circumstances, the identification information may be unique to a product. Rights associated with a product may be bound to the identification information and be used to manage the product in a variety of applications, use cases, and/or contexts. Management of such rights, however, introduces a number of challenges using conventional techniques.

Consistent with embodiments disclosed herein, identification information may be securely associated with products using secure tags, watermarks (which may be physically embedded on, printed, and/or otherwise attached to a product, and/or using other techniques for securely (and potentially indelibly) associating a unique identifier and/or other information with a product. In various embodiments, a secure tag may comprise a near-field communication (“NFC”) tag physically embedded in, attached to, and/or otherwise associated with product, although it will be appreciated that other types of secure tags may also be used.

Consistent with embodiments disclosed herein, NFT management paradigms may be used to manage, implement, and/or otherwise enforce rights associated with products in a variety of variety of applications, use cases, and/or contexts. In various disclosed embodiments, tags, watermarks, and/or associated information may be securely associated with one or more NFTs, which may allow for management of rights related to products associated with the secure tags, watermarks, and/or other information using NFT management techniques. In certain embodiments, an NFT may comprise a type of cryptographic token on a trusted ledger (e.g., a blockchain ledger, which may be distributed) that may represent and/or otherwise be associated with a product. This association may allow the product to be digitally represented and/or managed using the NFT.

Embodiments of the disclosed systems and methods may use key management and digital rights management (“DRM”) technologies in connection with NFT management paradigms. For example, using various aspects of the disclosed systems and methods, rights holders can manage the production of products to which the hold ownership rights (e.g., generation of such products using 3D printers and/or the like), ownership rights in products may be determined and/or validated, lost products may be managed and/or identified, and/or the like. In some embodiments, metadata associated with products may be stored in a server database, and the correlation of products and associated metadata may be securely stored in a trusted ledger, which may comprise a blockchain ledger.

In certain embodiments, marketplace services may be employed that interface with a token rights management (“TRM”) service implementing NFT management methods and providing tag and/or watermark management, trusted ledger management, and/or DRM services. Such a marketplace service may allow rights holders to list products and/or associated rights for sale, rent, and/or the like, facilitate transactions between parties in connection with such rights, and/or ensure that transacted rights are securely transferred and recorded as appropriate. Moreover, marketplace services consistent with various embodiments disclosed herein may allow for verification of the possession of a NFT and/or an associated asset and/or product, and/or for management of assets and/or products associated with NFTs that are lost and/or stolen.

In certain embodiments, marketplace services may facilitate, among other things, payment from consumers and/or other parties to rightsholders, management of rights to products using key management and/or DRM services and/or blockchain services, which may products and/or associated secure tags with tokens (e.g., NFTs) that may be managed using trusted ledgers and/or blockchains. In addition, fractional ownership rights may be associated and managed in connection with products in connection with embodiments of the disclosed marketplace services. Fractional ownership models may, among other things, enable multiple parties to acquire shares in products and/or transact in connection with such shares consistent with their relative ownership rights.

In various embodiments disclosed herein, products may comprise physical products (e.g., a shoe, a record, product inventory, luxury items, etc.). In some embodiments, a physical product may be associated with digital content digital products (e.g., digital content, which in some embodiments may comprise a digital description of and/or other information that may be used to generate a physical product such as 3D printing instructions. It will be appreciated that embodiments of the disclosed systems and methods may be used in connection with managing a wide variety of products and/or associated rights, and that any specific examples of products described herein are used for purposes of illustration and explanation and are not to be viewed as limiting.

### BRIEF DESCRIPTION OF DRAWINGS

The inventive body of work will be readily understood by referring to the following detailed description in conjunction with the accompanying drawings, in which:

FIG. 1 illustrates a non-limiting example of a product management ecosystem consistent with certain embodiment disclosed herein.

FIG. 2A illustrates a first part of a non-limiting example of a managed product creation process consistent with certain embodiments disclosed herein.

FIG. 2B illustrates a second part of a non-limiting example of a managed product creation process consistent with certain embodiments disclosed herein.

FIG. 2C illustrates a third part of a non-limiting example of a managed product creation process consistent with certain embodiments disclosed herein.

FIG. 2D illustrates a fourth part of a non-limiting example of a managed product creation process consistent with certain embodiments disclosed herein.

FIG. 3A illustrates a first part of a non-limiting example of a managed product ownership verification process consistent with certain embodiments disclosed herein.

FIG. 3B illustrates a second part of a non-limiting example of a managed product ownership verification process consistent with certain embodiments disclosed herein.

FIG. 3C illustrates a third part of a non-limiting example of a managed product ownership verification process consistent with certain embodiments disclosed herein.

FIG. 3D illustrates a fourth part of a non-limiting example of a managed product ownership verification process consistent with certain embodiments disclosed herein.

FIG. 4A illustrates a first part of a non-limiting example of a managed product printing process consistent with certain embodiments disclosed herein.

FIG. 4B illustrates a second part of a non-limiting example of a managed product printing process consistent with certain embodiments disclosed herein.

FIG. 4C illustrates a third part of a non-limiting example of a managed product printing process consistent with certain embodiments disclosed herein.

FIG. 4D illustrates a fourth part of a non-limiting example of a managed product printing process consistent with certain embodiments disclosed herein.

FIG. 5A illustrates a first part of a non-limiting example of a process for managing lost and/or stolen products consistent with certain embodiments disclosed herein.

FIG. 5B illustrates a second part of a non-limiting example of a process for managing lost and/or stolen products consistent with certain embodiments disclosed herein.

FIG. 5C illustrates a third part of a non-limiting example of a process for managing lost and/or stolen products consistent with certain embodiments disclosed herein.

FIG. 5D illustrates a fourth part of a non-limiting example of a process for managing lost and/or stolen products consistent with certain embodiments disclosed herein.

FIG. 5E illustrates a fifth part of a non-limiting example of a process for managing lost and/or stolen products consistent with certain embodiments disclosed herein.

FIG. 6A illustrates a first part of a non-limiting example of a tag possession verification process consistent with certain embodiments disclosed herein.

FIG. 6B illustrates a second part of a non-limiting example of a tag possession verification process consistent with certain embodiments disclosed herein.

FIG. 6C illustrates a third part of a non-limiting example of a tag possession verification process consistent with certain embodiments disclosed herein.

FIG. 6D illustrates a fourth part of a non-limiting example of a tag possession verification process consistent with certain embodiments disclosed herein.

FIG. 6E illustrates a fifth part of a non-limiting example of a tag possession verification process consistent with certain embodiments disclosed herein.

FIG. 7 illustrates a flow chart of a non-limiting example of a method of managing a missing product consistent with certain embodiments of the present disclosure.

FIG. 8 illustrates a non-limiting example of a system that may be used to implement certain embodiments of the systems and methods of the present disclosure.

### DETAILED DESCRIPTION OF THE INVENTION

A description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to certain drawings. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. Given examples are to be understood as illustrative and non-limiting, whether indicated explicitly as such or not. In addition, the steps of any method disclosed herein do not necessarily need to be executed in any specific order, or even sequentially, nor need the steps be executed only once, unless otherwise specified.

Embodiments of the disclosed systems and methods may provide for dynamic management of products in a secure way, where the rights of rights holders in such products are respected and/or otherwise enforced. Various embodiments disclosed herein may use trusted ledgers to securely record certain assertions relating to the products, rightsholders, and/or various ecosystem participants. Such assertions may be used in connection with rights binding, product management, rights, ownership, and/or product verification, product printing and/or generation, lost and/or stolen product management, and/or other operations in connection with a variety of transactions associated with products and/or associated NFTs.

It will be appreciated that, as used herein, the term products may be used to generally refer to a wide variety of types of products that may include, for example and without limitation, a shoe, a handbag, a vinyl record, product inventory, a luxury item, and/or any other type of physical product and/or physical product associated with a digital asset. In certain embodiments, the association of the physical product with an NFT consistent with various aspects of the disclosed embodiments may allow the product to be represented digitally and managed accordingly.

As detailed herein, associations between and/or assertions relating to products and/or tokens may be managed using trusted ledgers, which in some implementations may comprise blockchain ledgers. Certain embodiments may use one or more commercial blockchain ledgers such as, for example and without limitation, the FLOW blockchain, and blockchain connector services to provide mechanisms to readily implement aspects of the disclosed systems and methods with such established blockchain architectures.

In various disclosed embodiments, trusted databases, ledgers, and/or the like (which may be generally referred to herein as “trusted ledgers” and/or variations of the same), may be used to record and/or otherwise manage various assertions associated with digital assets and/or NFTs. In some embodiments, such databases and/or ledgers may be distributed, and may be referred to herein as trusted immutable distributed assertion ledgers (“TIDALs”) and/or variations of the same. In some embodiments, trusted ledgers used in connection with various aspects of the disclosed embodiments may comprise blockchain ledgers. Databases and/or ledgers may, in various embodiments, be public, private, and/or a combination thereof. In certain embodiments, a TIDAL may comprise a public indelible distributed database (“PIDD”). TIDALs consistent with various aspects of the disclosed embodiments may be associated with a variety of properties including, for example, ledger processes that may be resistant to byzantine failures, entries that may be immutable and/or relatively immutable, entries that may be time-synced (at least in part), entries that may be scalable, and/or entries that may be available for relatively fast lookup.

Certain aspects of the disclosed ecosystems, architectures, and/or processes may be performed by and/or otherwise be performed in connection with one or more entities, services, and/or systems that may include, for example and without limitation, one or more of:

User—A user may comprise a user system and/or device that may interact with other entities, systems, and/or services described herein. In some embodiments, the user may be an original rights holder, an owner (e.g., an owner in entirety and/or a fractional owner), a rights holder, a buyer, a renter, and/or a consumer of a product.

Rights Holder—An entity, which may be a user, holding rights in a product. In some instances, the rights holder may be an original rights holder (“ORH”) holding the original rights granted to and/or otherwise associated with a product. In certain embodiments, an ORH may be a creator of a product.

Secure Tag—A secure identifier associated with a product, which in certain instances herein may be referred to simply as a tag. In some embodiments, a secure tag may comprise a physical tag associated with a physical product. For example, the secure tag may comprise an NFC tag storing and/or otherwise encoding identification information associated with a product that, in some embodiments, may be unique identification information associated with the product. In certain embodiments, unique information associated with the product may comprise a public key associated with a private key generated by and/or otherwise derived from information unique to the product (e.g., a physical unclonable function (“PUF”)) and/or from an injected key pair. In further embodiments, the tag may comprise a watermark and/or other encoded information associated with the product. The watermark may comprise a physical watermark (e.g., a watermark encoded using a texture and/or shape and/or the like), a printed watermark, and/or any other type of watermark. The watermark may directly encode information and/or may reference and/or otherwise link to associated information. In connection with digital products, the tag may comprise a digital tag, fingerprint, and/or watermark securely and/or indelibly associated with the digital product.

Tag Reader—A device and/or system that may be capable of reading information stored and/or otherwise encoded on a tag. In some embodiments, the tag reader may comprise an NFC tag reader. In further embodiments, the tag reader may comprise a camera and/or other scanning system configured to capture watermark information encoded in a product. In yet further embodiments, the tag reader may not necessarily be a stand-alone system and/or device, but instead may be integrated in another system, device, and/or service. In connection with digital tags (e.g., watermarks included in digital content and/or software), the tag reader may comprise a software service and/or function configured to access and/or otherwise read the digital tag information.

Product—An item to which rights may be attached. A product may comprise a physical product such as, for example and without limitation, a shoe, a handbag, a vinyl record, and/or the like. It will be appreciated that embodiments of the disclosed systems and methods may be used in connection with managing a wide variety of products and/or associated rights, and that any specific examples of products described herein are used for purposes of illustration and explanation and are not to be viewed as limiting.

Marketplace Service—An entity and/or service, which may comprise a third-party entity that offers a marketplace service allowing, for example and without limitation, users to interact with products listed and/or otherwise registered to a marketplace in connection with various transactions (e.g., sale, rental, transfer of rights, ownership and/or tag verification, lost and/or stolen product management, and/or the like) and/or other entities to interact with the marketplace service to engage in such transactions. In some embodiments, the marketplace service may comprise a third-party service that uses a trusted data management platform (“TIP”) service (or, in certain instances herein, more generally a “trusted data management service”) for NFT and/or DRM implementations. In some embodiments, the marketplace service may include an abstraction layer allowing for streamlined interfacing with the marketplace service by other services.

Trusted Ledger Service-A service that manages a trusted ledger, which in some implementations may comprise a blockchain and/or a TIDAL, in connection with various assertion management interactions (e.g., assertion recordation, assertion verification, etc.) with other systems and/or services. In some embodiments, the blockchain service may comprise a public blockchain service (e.g., the FLOW blockchain) managing a public blockchain. In further embodiments, the blockchain service may comprise a service managing a private blockchain. In some embodiments, the blockchain service may be offered by a token rights management (“TRM”) system and/or service, as described in more detail below. Although various examples described herein may use a blockchain and/or a TIDAL, it will be appreciated that various embodiments and aspects of the disclosed systems and methods may be implemented using a variety of other trusted databases and/or ledgers that may, or may not, have certain attributes associated with a blockchain and/or a TIDAL. The trusted ledger service may further manage a wallet service (which in further implementations could be offered by a separate service) in connection with managing digital wallets (e.g., cryptographic currency wallets) that may be used in connection with various interactions and/or transactions involving the various ecosystems and/or architectures detailed herein.

TRM Service—A TRM service may allow for a marketplace service and/or other entities to interact with various token management services and engage in various transactions and/or interactions involving the ecosystem detailed herein. The TRM service may offer orchestrator services, identity access management (“IAM”) services, DRM and/or key management services (“KMS”) services (e.g., services providing key management functionality including, for example and without limitation, key generation, storage, management, and/or the like), blockchain connector services (e.g., allowing for integration of various systems and/or services with established commercial blockchain and/or digital wallet services), and/or database services, which may be used to store various information relating to products and/or associated NFTs and/or metadata and/or products themselves (in the case of digital products).

Tag Service—A service that may be used in connection with various secure tag management, verification, and/or authentication activities. In some embodiments, the tag service may be offered by the TRM service.

Orchestrator Service—A TRM service that may be used in connection with orchestrating and/or managing various services and/or operations performed by the TRM service and/or constituent services.

Blockchain Connector Service—The blockchain connector service may allow for the TRM service to interact with the blockchain service. In some embodiments, the blockchain connector service may be configured to structure various requests, queries, and actions directed to a blockchain service based on the particular configuration and/or requirements of the associated blockchain.

DB—A database that may be used to store and/or manage information used by the TRM service, which may comprise various product and/or processing status tables.

Event Indexer—a service that may allow for certain indexing and/or other management interactions with a blockchain service. In some embodiments, Graffle may be used an indexer service for interacting with a FLOW blockchain, although other services may also be used.

Printer—A system and/or device that may be used to print, generate, render, and/or otherwise create a product. In certain non-limiting examples, a printer system may comprise a 3D printing system.

It will be appreciated that although illustrated and/or described as separate entities, services, and/or systems, one or more of the above-described entities, services, and/or systems may be implemented by a single entity, service, and/or system and/or by any suitable configuration and/or combination of entities, services, and/or systems.

A variety of tables may be used in connection with managing tokens in connection with various disclosed embodiments. In some embodiments, the tables may be managed by a DB service, which may be included in the TRM service and/or a marketplace service. These tables may comprise, for example and without limitation, one or more of:

Task table—A task table may comprise, for example and without limitation, one or more of a task ID, marketplace ID, creator ID, asset ID/product ID (potentially used for update), title, task timestamp, asset/product, status (e.g., processing, done, failed, deleted, etc.), a type of task (e.g., upload, update, delist, delete), etc.

Product table—A product table may comprise, for example and without limitation, one or more of a product ID, product serial ID, marketplace ID, name, serial number, type (e.g., public or private), preview URL, listed timestamp, owner ID, ORH ID, business-condition (e.g., an array of business conditions), sell price, rent price, rental period, metadata (e.g., JSON), product assertion, fact, delist, delete, invitees (e.g., list of invitee IDs), etc.

Transaction table—A transaction table may comprise, for example and without limitation, one or more of a transaction ID, marketplace ID, owner ID, consumer ID, product serial ID, timestamp, business condition, sell-price, rent-price, rental expiry date, etc.

Marketplace user table-A marketplace user table may comprise, for example and without limitation, one or more of a user ID, e-mail, name, account creation timestamp, balance, role (e.g., a role supported by marketplace services 102), etc.

### Marketplace Services and Asset Management

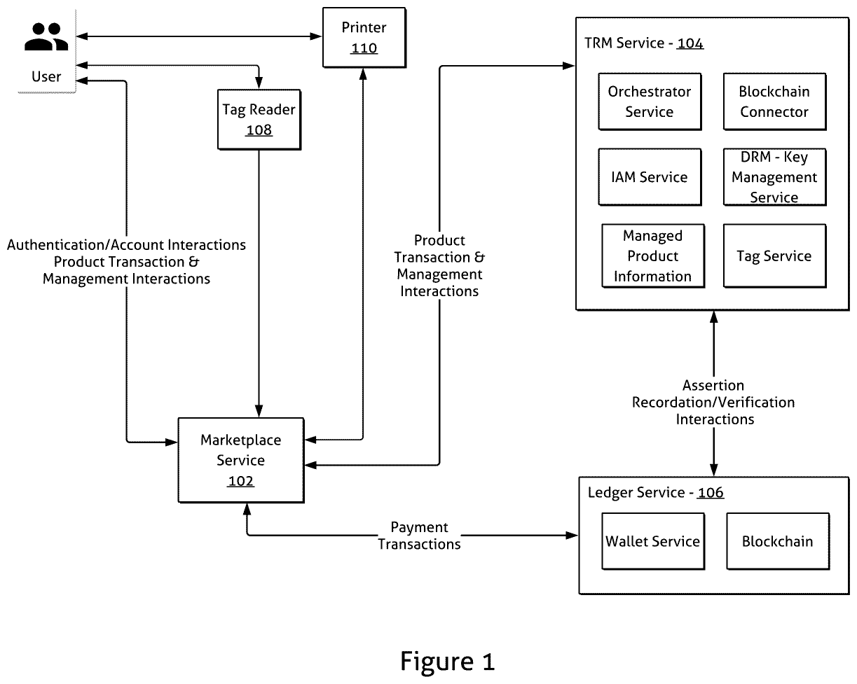

FIG. 1 illustrates a non-limiting example of a digital asset management ecosystem consistent with certain embodiment disclosed herein. As shown, a user may interact with a marketplace service 102 in connection with various asset management interactions and/or interactions. In some embodiments, the user may be an original rights holder, an owner (e.g., an owner in entirety and/or a fractional owner), a rights holder, a buyer, a renter, and/or a consumer of a product, and/or any other entity interacting with the marketplace service 102. In further embodiments, as discussed in more detail below, other services may interact with the marketplace service 102 including, for example and without limitation, tag reader systems 110, product printer 112 and/or generation systems (e.g., 3D printers and/or the like).

Users and/or services may among other things, manage their accounts with the marketplace service 102, login and/or authenticate access with the marketplace service 102, and/or engage in a variety of product transactions with the marketplace service 102. The marketplace service 102 may interact with a TRM system 104 in connection with a variety of product and/or NFT management processes consistent with various disclosed embodiments.

The TRM system 104 may include, for example and without limitation, an orchestrator service, an IAM service, a DRM service and/or KMS (which indeed may be the same service), a blockchain connector service facilitating interactions with a trusted ledger and/or ledger service 106, a tag service, managed product information and/or other DB information, which may comprise a variety of metadata and/or information relating to managed products, potentially including digital representations and/or files of managed products themselves. In connection with various transactions and/or interactions relating to managed products, the TRM system 104 may interact with a media service 108 and/or a trusted ledger service 106.

In various embodiments, products may be managed in accordance with one or more enforced business conditions. Business conditions may include permitted actions that may be performed in connection with a product and may be set by entities that hold certain rights to the product. For example and without limitation, business conditions may be used to manage products and/or associated NFTs based on sell models, rental models, subscription models, rent-ownership models, use models, and/or the like, which may be managed by the marketplace service 102 and/or the TRM service 104.

Business parameters and/or conditions associated with products may comprise information relating to, for example and without limitation, information relating to product creators and/or co-creators, information relating to ownership shares, licensing terms (e.g. this can be sold as a non-fungible serialized object like #1 of 20, this can be part of a subscription service, this can be licenses in specific territories, this can be resold, this can be loaned or not for specific time periods or by limited numbers of people, etc.), which can be as arbitrarily complex as can be represented electronically using any mechanism such as but not limited to DRM conditions. It will be appreciated that a variety of business conditions may be associated with digital assets and/or products via metadata in connection with various embodiments disclosed herein.

Business conditions, which may be expressed in metadata, may further define an indication of fractional ownership and/or other rights held in connection with products and/or associated NFTs. In certain embodiments, such fractional rights may be expressed in terms of ownership and/or rights holding shares, cuts, and/or percentages, although other methods and/or ways of implementing fractional ownership and/or rights holding are also envisioned. For example and without limitation, business conditions may express an indication of a name and/or other identity of rights holders and associated ownership rights and/or percentages of ownership rights for a product and/or associated NFT(s). In various embodiments, such fractional ownership and/or rights and/or rights may be traded and/or otherwise sold and/or exchanged using services enabled by embodiments of the disclosed ecosystem. Moreover, as discussed in more detail below, payment models and/or mechanisms between owners and/or rightsholders may be implemented based, at least in part, on fractional ownership and/or rights information detailed in business conditions.

The trusted ledger service 106 may provide various trusted ledger and/or blockchain and/or cryptographic wallet services which may be leveraged by the marketplace service 102 and/or the TRM service 104 in connection with the disclosed embodiments. For example, a blockchain ledger managed by the ledger service 106 may be used to securely record certain assertions relating to products, rightsholders, and/or various ecosystem participants. Such assertions may be used in connection with rights binding, content packaging, management, and/or protection operations in connection with a variety of transactions associated with products and/or associated NFTs.

Interactions between the marketplace service 102, the TRM service 104, the media service 106, and the ledger service 108 may facilitate a number of product management interactions and/or transactions including, for example and without limitation, registering and/or creation of managed products and/or NFTs, purchasing and/or accessing products via a variety of paradigms (e.g., rental, sale, etc.), updating products, deleting managed products, bundling and/or unbundling products, inviting and/or disinviting collaborators to interact with products, transferring ownership rights of products and/or associated tokens, including fractional ownership rights and/or other rights (e.g., revenue rights), product transaction history management, product and/or owner verification, product printing and/or generation, lost and/or stolen product management, product and/or associated tag possession verification, and/or the like.

### Product Creation

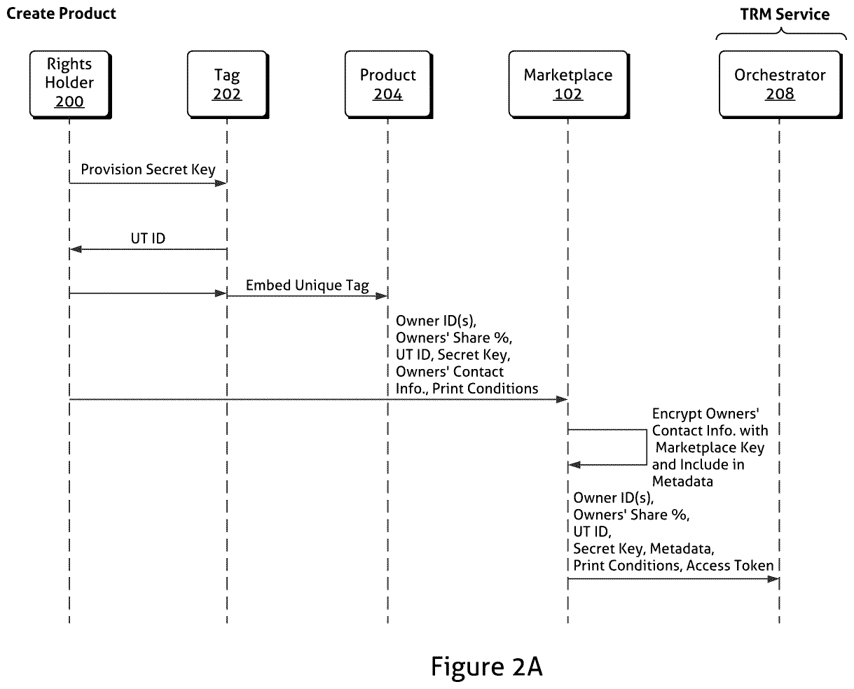

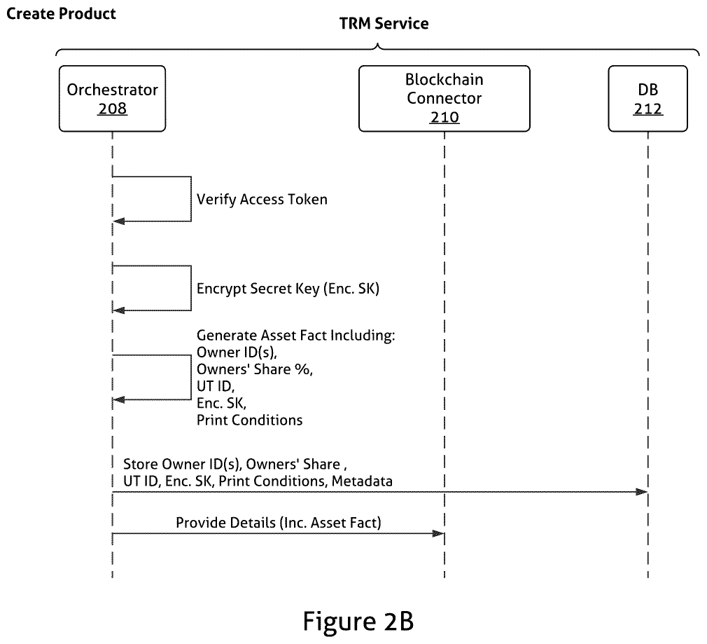

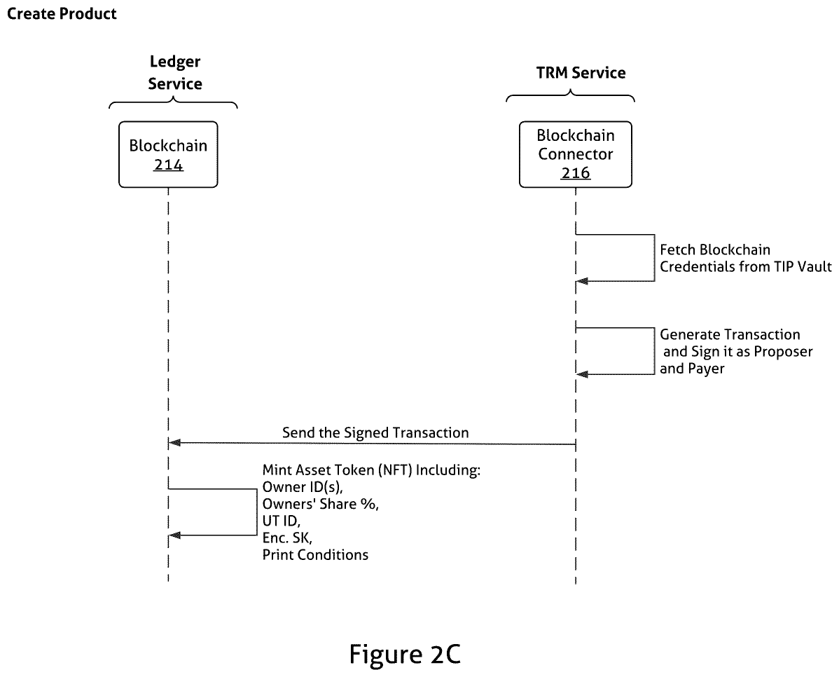

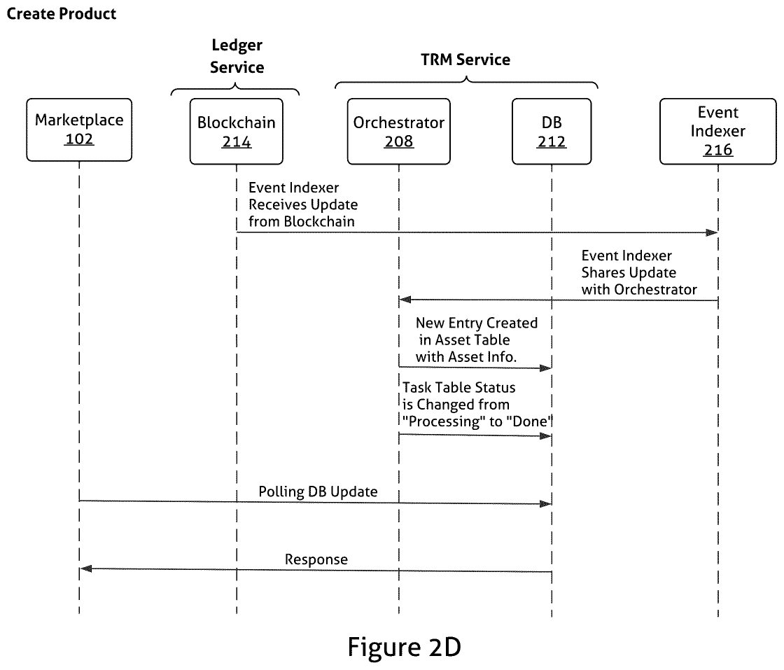

FIGS. 2A-2D illustrate conceptual diagrams showing non-limiting examples of various aspects of a product creation and/or registration process consistent with certain embodiments disclosed herein. As shown, a rights holder 200, which may be an ORH, may provision a secret key to a tag 202. In some embodiments, the tag 202 may be a unique tag. The rights holder 200 may obtain an identifier (e.g., a unique identifier) associated with the tag 202, which in certain embodiments may be generated at least in part by the provisioned secret key. The tag 202 may be embedded and/or otherwise included in the product 204.

The rights holder 200 may communicate to a marketplace service 102 an ID associated with a product owner and/or the rights holder 200, a percentage of ownership and/or associated rights held by the rights holder 200 (e.g., a share % if applicable, which in some embodiments may be expressed as a number of shares of total available shares owned by the rights holder 200), the tag identifier, and the secret key. In some embodiments, rules and/or conditions for rendering, printing, generating, creating, and/or duplicating an associated product, which may be described herein as business and/or print conditions, may be shared with the marketplace service 102, which may be enforced as part of a DRM process, as discussed in more detail below.

In certain embodiments, contact information associated with the owner and/or rights holder 200 may also be shared with the marketplace service 102. To protect any sensitive or personal information that may be included in the shared contact information, the marketplace service 102 may encrypt the contact information with a key associated with the marketplace service 102 and store it in metadata associated with the product 204.

The owner and/or rights holder identifier, percentage of ownership and/or rights, tag identifier, secret key, metadata associated with the product, an access token (e.g., an access token provisioned to the marketplace service 102 by the TRM service) and/or any conditions associated with the product (e.g., printing conditions) may be shared by the marketplace service 102 with an orchestrator service 208 of the TRM service. The orchestrator service 208 may verify the access token. If the access token is verified, the service may encrypt the secret key (e.g., using a key associated with the TRM service).

A product fact (which may be also referred to herein as an assertion) may be generated by the orchestrator service 208 that includes, for example and without limitation, one or more of an owner and/or rights holder identifiers, a percentage of associated ownership and/or rights, a tag identifier, the encrypted secret key, and/or any conditions associated with the product. The orchestrator service 208 may further store the owner and/or rights holder identifiers, percentage of associated ownership and/or rights, tag identifiers, encrypted secret key, and/or any conditions associated with the product, and/or metadata associated with the product in a DB 212 of the TRM service.

The orchestrator service 208 may share various information to a blockchain connector service 210 of the TRM service configured to interface with a blockchain service 214. For example, the product fact and/or other associated details may be shared with the blockchain connector service 216 for recordation in a blockchain 214 managed by the ledger service. The blockchain connector service 216 may retrieve blockchain access credentials and, using the retrieved credentials, generate a signed transaction that includes the product fact for recordation in the blockchain 214. For example, the blockchain connector service 216 may generate a transaction including the product fact and sign it as a proposer and payer (e.g., with the payer being the TRM service, the marketplace service 102, and/or the rights holder 200). The blockchain connector service 216 may share the signed transaction with the blockchain 214.

Upon receipt of the signed transaction, the ledger service may mint an asset token (e.g., an NFT) and record in the blockchain 214. The minted asset token may comprise, for example and without limitation, the owner and/or rights holder identifiers, percentage(s) of associated ownership and/or rights, tag identifier, the encrypted secret key, and/or any conditions associated with the product (e.g., print conditions), and/or information relating to the same.

In certain embodiments, an event indexer service 216 may receive an update from the ledger service. The update may be shared by the event indexer service 216 with the orchestrator service 208 of the TRM service. In some embodiments, the orchestrator service 208 may manage a product table included in the DB 212 of the TRM service. Based on the update shared by the event indexer service 216, a new entry may be created in the product table. In addition, the status of recording the transaction associated with the product creation may be updated in task table which may manage the status of various transactions and/or operations performed by the TRM service and/or its constituent services (e.g., the orchestrator service 208). In various embodiments, the DB 212 of the TRM service may be queried for updates through periodic and/or event driven polling and/or querying by the marketplace service 102, which may receive an associated response.

### Product and Owner(s) Verification

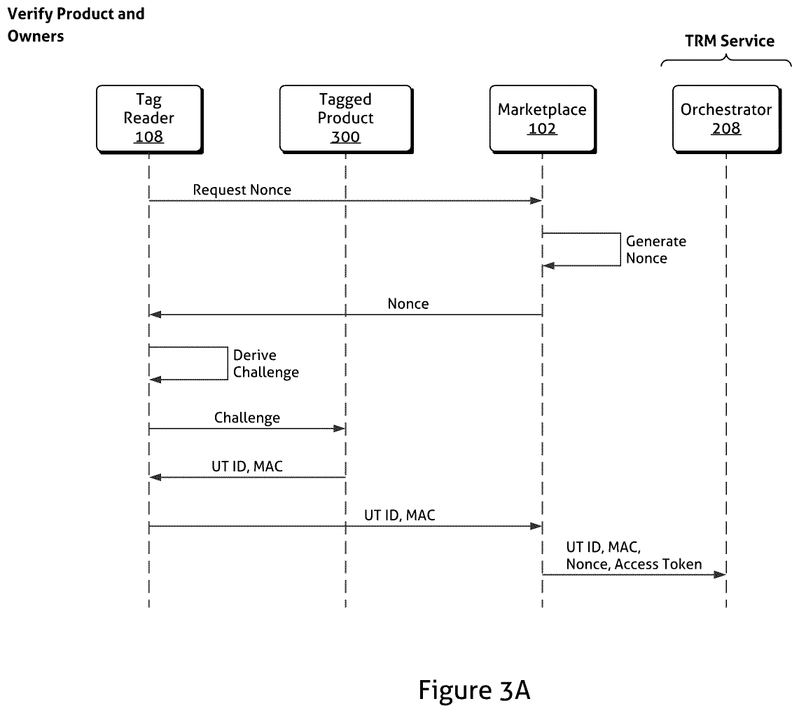

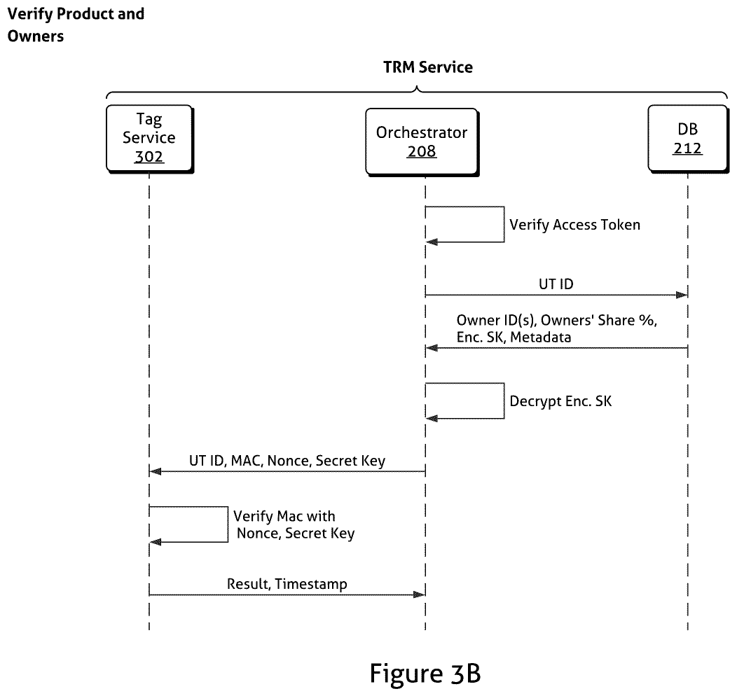

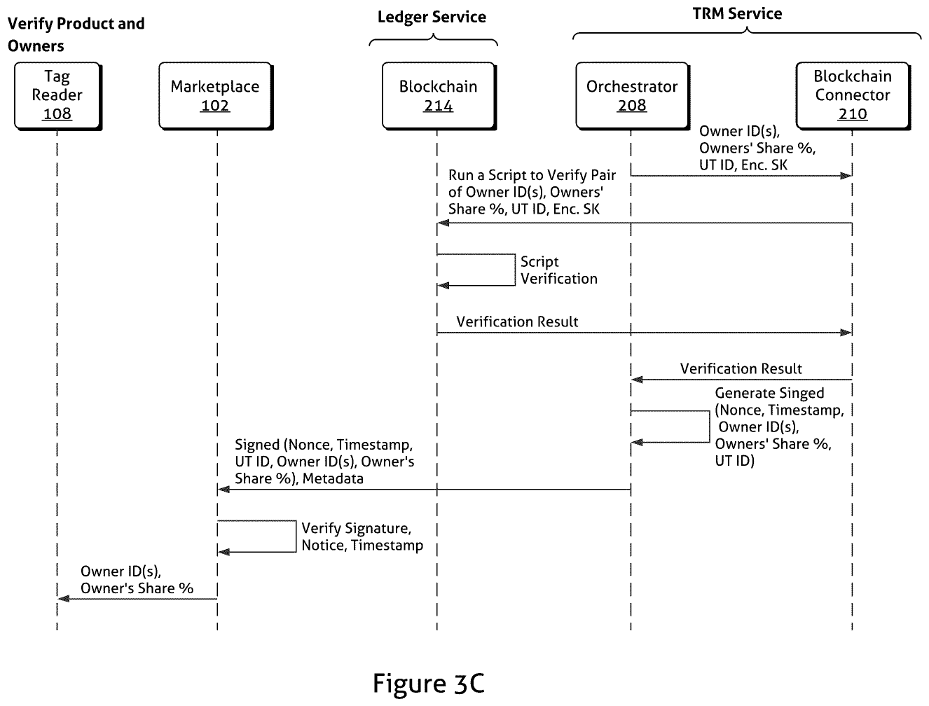

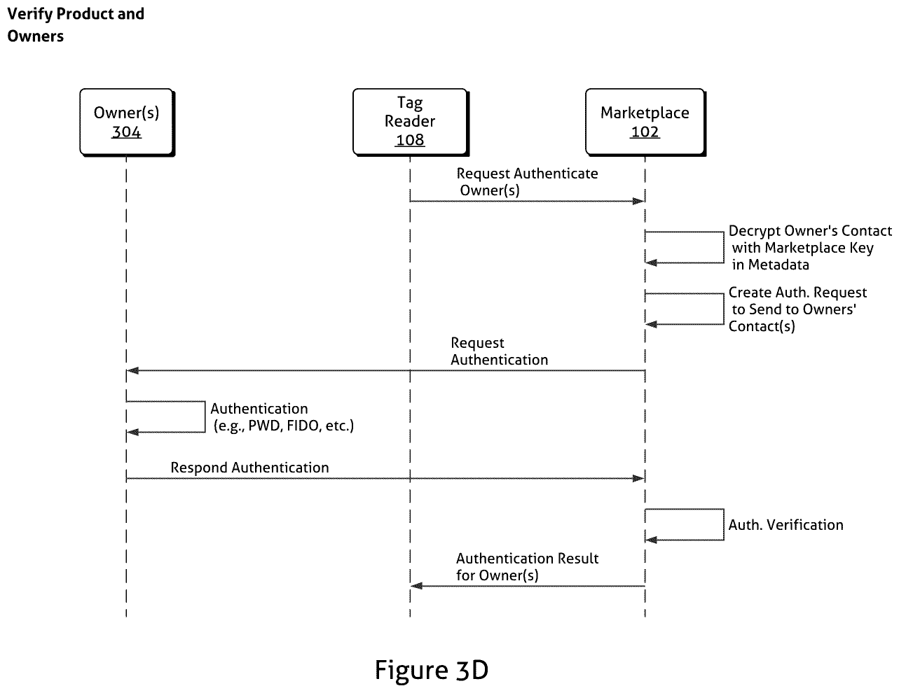

FIGS. 3A-3D illustrate conceptual diagrams showing non-limiting examples of various aspects of a product and/or ownership verification process consistent with certain embodiments disclosed herein. A tag reader 108 used to verify a product and/or an associated owner 304 may request a nonce from the marketplace service 102. In response to the request, the marketplace service 102 may generate the nonce and return it to the tag reader 108. Based on the received nonce, the tag reader 108 may generate and/or otherwise derive a challenge (e.g., a challenge value and/or associated information). The challenge may be issued by the tag reader 108 to the tag embedded in the product 300.

In response, the tag included in the tagged product 300 may return to the tag reader 108 the tag identifier and a message authentication code (“MAC”) calculated by the tag based on the issued challenge and provisioned secret key. The tag reader 108 may communicate the returned tag identifier and MAC to the marketplace service 102. The marketplace service 108 may communicate the received tag identifier and MAC, the nonce generated by the marketplace service 102 and shared with the tag reader 108, and an access token (e.g., an access token provisioned to the marketplace service 102 by the TRM service) to the orchestrator service 208 of the TRM system. Although in various embodiments and examples herein described a MAC-based challenge in connection with tag verification, it will be appreciated that other techniques for tag verification may also be used. For example and without limitation, the tag may return to the tag reader 108 a message that is encrypted and/or signed using a key (e.g., a private key) stored by and/or otherwise associated with the tag. This signed and/or encrypted message may be used in connection with verifying the tag with the tag service 302 of the TRM system.

The orchestrator service 208 may verify the access token. If the access token is verified, the service 208 may query the DB 212 with the tag identifier and, in response, receive the identifiers(s) associated with product(s) and/or rights holder(s) 304, a percentage of ownership and/or associated rights held by the owner(s) and/or rights holder(s) 304 (e.g., a share % if applicable), the encrypted secret key, and/or metadata stored by the DB 212 associated with the subject tag identifier. Using a decryption key, the orchestrator service 208 may decrypt the secret key returned from the DB 212 and provide the decrypted secret key to the tag service 302 along with the tag identifier, the MAC, and the nonce.

The tag service 302 may verify the MAC using the provided nonce and the decrypted secret key, returning a result to the orchestrator service 208 along with an associated timestamp. If verified by the tag service 302, the orchestrator service 208 may query the blockchain connector service 210 with the tag identifier, the identifier(s) associated with product owner(s) and/or rights holder(s) 304, the percentage of ownership and/or associated rights held by the owner(s) and/or rights holder(s) 304, and the encrypted secret key. The blockchain connector service 210 may run a script to verify whether the blockchain 214 includes an entry corresponding to the tag identifier, the identifiers(s) associated with product owner(s) and/or rights holder(s) 304, the percentage of ownership and/or associated rights held by the owner(s) and/or rights holder(s) 304, and the encrypted secret key. The blockchain 214 may verify whether the entry is included in the blockchain 214, returning the result to the blockchain connector service 210 which may be shared with the orchestrator service 208.

The orchestrator service 208 may generate a signature based on one or more of the nonce, the timestamp returned from the tag service (e.g., which may be used to check and/or otherwise verify freshness of the tag information managed by the tag service), the identifiers(s) associated with product owner(s) and/or rights holder(s) 304, the percentage of ownership and/or associated rights held by the owner(s) and/or rights holder(s) 304, and/or the tag identifiers. The signature may be shared with the marketplace service 102 along with associated metadata.

The marketplace service 102 may verify one or more of the received signature, nonce, and/or timestamp. Based on the verification, the marketplace service 102 may provide the tag reader 108 with an indication of the verified identifiers(s) associated with product owner(s) and/or rights holder(s) 304 and/or the percentage of ownership and/or associated rights held by the owner(s) and/or rights holder(s) 304.

As discussed above, in some implementations, an owner and/or rights holder 304 may share contact information with a marketplace service 102. The tag reader 108 and/or a user thereof may wish to authenticate the owner and/or rights holder 304, issuing a request to the marketplace service 102. The marketplace service 102 may decrypt encrypted contact information (if any) associated with the owner and/or rights holder 304 stored by the marketplace service 102 using an associated marketplace decryption key. The marketplace service 102 may then generate an authentication request and send the request to the rights holder and/or owner 304 based on the decrypted contact information.

Upon receipt of the authentication request, the owner and/or rights holder 304 may authenticate their identity (e.g., using ID/password authentication, multi-factor authentication (“MFA”), FIDO, etc.), providing an authentication response to the marketplace service 102. The marketplace service 102 may verify the information provided in the authentication response and, if valid, return an authentication result to the tag reader 108.

Product Printing and/or Generation

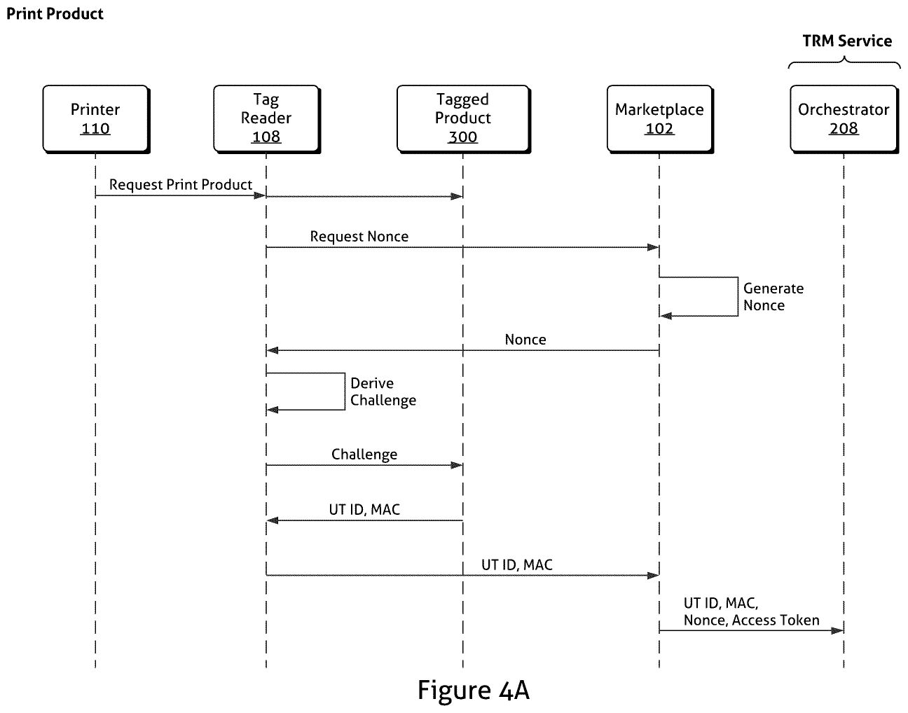

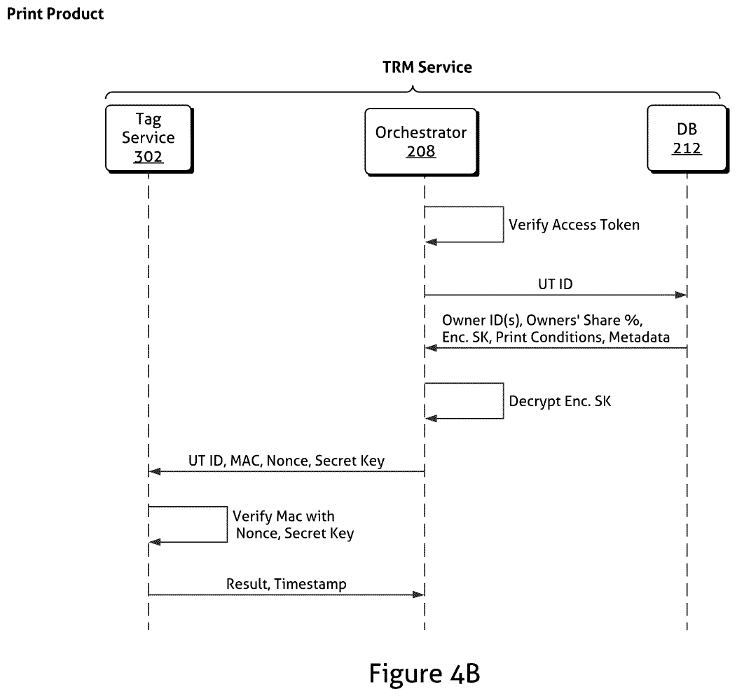

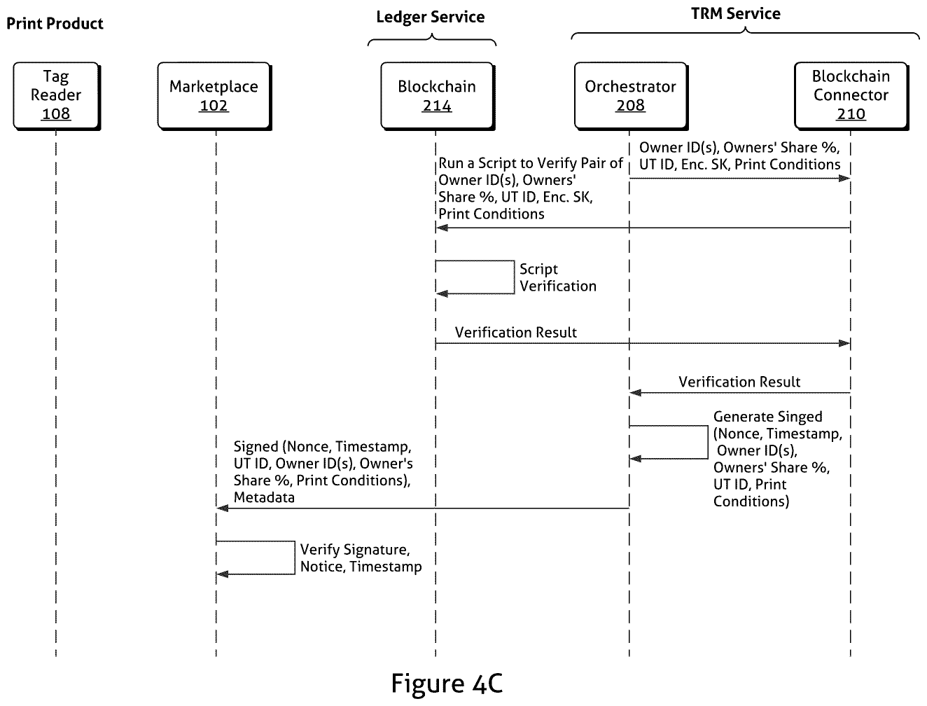

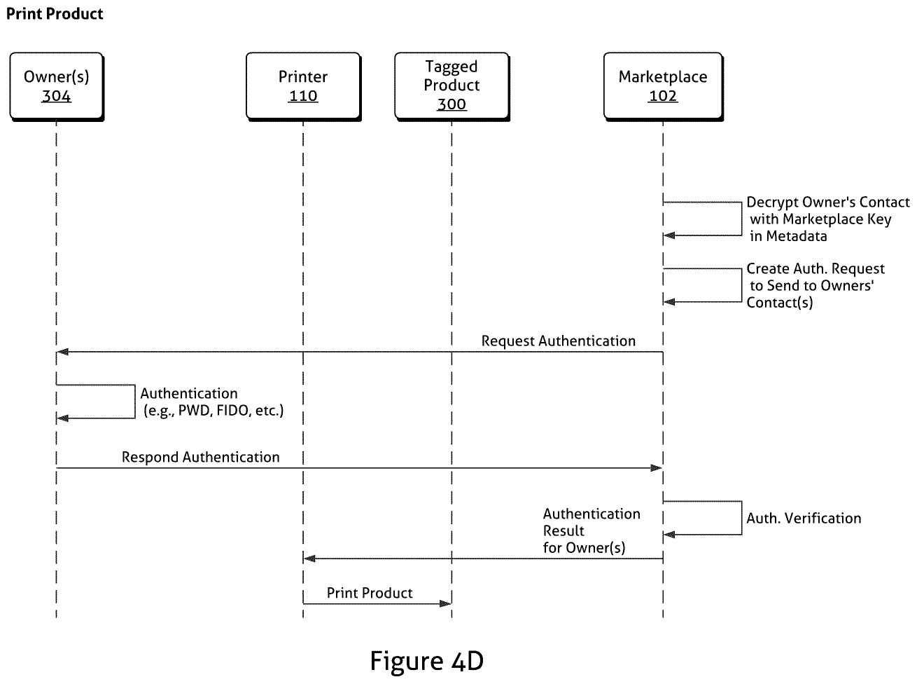

FIGS. 4A-4D illustrate conceptual diagrams showing non-limiting examples of various aspects of a product printing process consistent with certain embodiments disclosed herein. As discussed above, in some implementations, a tagged product 300 may comprise digital information that may be provided to a device (e.g., a printing system 110) that may be used to render and/or otherwise generate a corresponding physical product. For example and without limitation, the tagged product 300 may comprise input digital data that may be provided to a 3D printing system to print and/or otherwise generate a product. The tag may comprise fingerprint and/or watermark data securely associated with digital data representing the product that may be used to generate the physical item.

As shown, an owner and/or rights holder 200 may issue a request to print a physical item to a printing system 100. The product (e.g., digital data and/or instructions that may be used to render the physical item by the printing system) may be provided to the printing system 110.

The printing system 110 may request a nonce from the marketplace service 102. In response to the request, the marketplace service 102 may generate the nonce and return it to the printing system 110. Based on the received nonce, the printing system 110 may generate and/or otherwise derive a challenge (e.g., a challenge value). The challenge may be issued by the printing system 110 to the tag embedded in the tagged product 300 (e.g., the digital tag, fingerprint, and/or watermark).

In response, the tag may return to the printing system 110 the tag identifier and a MAC calculated based on the issued challenge and provisioned secret key. The printing system 110 may communicate the tag identifier, the MAC, the nonce generated by the marketplace service 102 and shared with the printing system 110, and an access token (e.g., an access token provisioned to the marketplace service 102 by the TRM service) to the orchestrator service 208 of the TRM system.

The orchestrator service 208 may verify the access token. If the access token is verified, the orchestrator service 208 may query the DB 212 with the tag identifier and, in response, receive the identifiers(s) associated with product owner(s) and/or rights holder(s), a percentage of ownership and/or associated rights held by the owner(s) and/or rights holder(s) (e.g., a share % if applicable), an encrypted secret key, and/or metadata stored by the DB 212 associated with the subject tag identifier. In some embodiments, DB 212 may further return print conditions associated with the product to the orchestrator service.

A variety of print conditions may be used in connection with embodiments disclosed herein. In some embodiments, print conditions may comprise data used by the printing system 110 to print a physical product based on the corresponding digital input data representing the product. In certain embodiments, if the input data is encrypted, the print conditions may comprise a key that may be used to decrypt the data. Print conditions may further comprise an indication of a number of physical products that may be printed corresponding to the managed product. In further embodiments, print conditions may comprise one or more parameters (e.g., user configurable parameters) that may comprise, for example and without limitation, one or more of a color of a physical item corresponding to the digital product, the size of a physical item corresponding to the digital product, material(s) to be used, and/or the like.

Using a decryption key, the orchestrator service 208 may decrypt the secret key returned from the DB 212 and provide the decrypted secret key to the tag service along with the tag identifier, the MAC, and the nonce.

The tag service 302 may verify the MAC using the provided nonce and the decrypted secret key, returning a result to the orchestrator service 208 along with an associated timestamp. If verified by the tag service, the orchestrator service 208 may query the blockchain connector service 210 with the tag identifier, the identifiers(s) associated with product owner(s) and/or rights holder(s), the percentage of ownership and/or associated rights held by the owner(s) and/or rights holder(s), the encrypted secret key, and/or any applicable print conditions. The blockchain connector service 210 may run a script to verify whether the blockchain 214 managed by the ledger service includes an entry corresponding to the tag identifier, the identifier(s) associated with product owner(s) and/or rights holder(s), the percentage of ownership and/or associated rights held by the owner(s) and/or rights holder(s), the encrypted secret key, and/or the print conditions. The ledger service may verify whether the entry is included in the blockchain 214, returning the result to the blockchain connector service 210 which may be shared with the orchestrator service 208.

The orchestrator service 208 may generate a signature based on one or more of the nonce, the timestamp returned from the tag service (e.g., which may be used to check and/or otherwise verify freshness of the tag information managed by the tag service, the identifiers(s) associated with product owner(s) and/or rights holder(s), the percentage of ownership and/or associated rights held by the owner(s) and/or rights holder(s), tag identifier, and/or applicable print conditions. The signature may be shared with the marketplace service 102 along with associated metadata.

The marketplace service 102 may verify one or more of the received signature, nonce, and/or timestamp. The marketplace service 102 may further decrypt any encrypted contact information associated with the owner and/or rights holder stored by the marketplace service 102 using an associated marketplace decryption key. The marketplace service 102 may then generate an authentication request and send the request to the rights holder and/or owner 304 (or potentially multiple rightsholders and/or owners) based on the decrypted contact information.

Upon receipt of the authentication request, the owner(s) 304 and/or rights holder(s) may authenticate their identity (e.g., using ID/password authentication, MFA, FIDO, etc.), providing an authentication response to the marketplace service 102. The marketplace service 102 may verify the information provided in the authentication response and, if valid, return an any applicable print conditions and/or instructions to the printing system 110. The printing system 110 may then render the physical item corresponding to the digital product according to given print conditions and/or instructions.

Lost and/or Stolen Asset Management

In certain circumstances, a physical product associated with a token may be lost and/or otherwise stolen from an owner. The owner may report the lost product. In response, the marketplace service may suspend certain buy and/or sell transactions for the token associated with the product. If there is an attempt to authenticate a lost product with a tag reader, the tag reader may inform the person attempting authentication that it is a lost and/or stolen product. The person attempting authentication may be further recorded as a witness that the product is lost and/or stolen. In certain implementations, the person attempting authentication may be contacted and given an opportunity to provide details about the lost product such as where it was found. In further embodiments, geolocation information (e.g., GPS coordinates) associated with the tag reader may be obtained (potentially based on consent of the authenticating user).

In certain embodiments, after a product has been marked lost and/or stolen, its authenticity may be reported to, for example and without limitation, (a) an authenticated and trusted user and/or (b) an authenticated user that agrees to identify their location. This may reduce the likelihood of a black-market sale of the stolen item, because a buyer may have more limited ways of trusting the authenticity of the physical product (in addition to not being able to own the token itself).

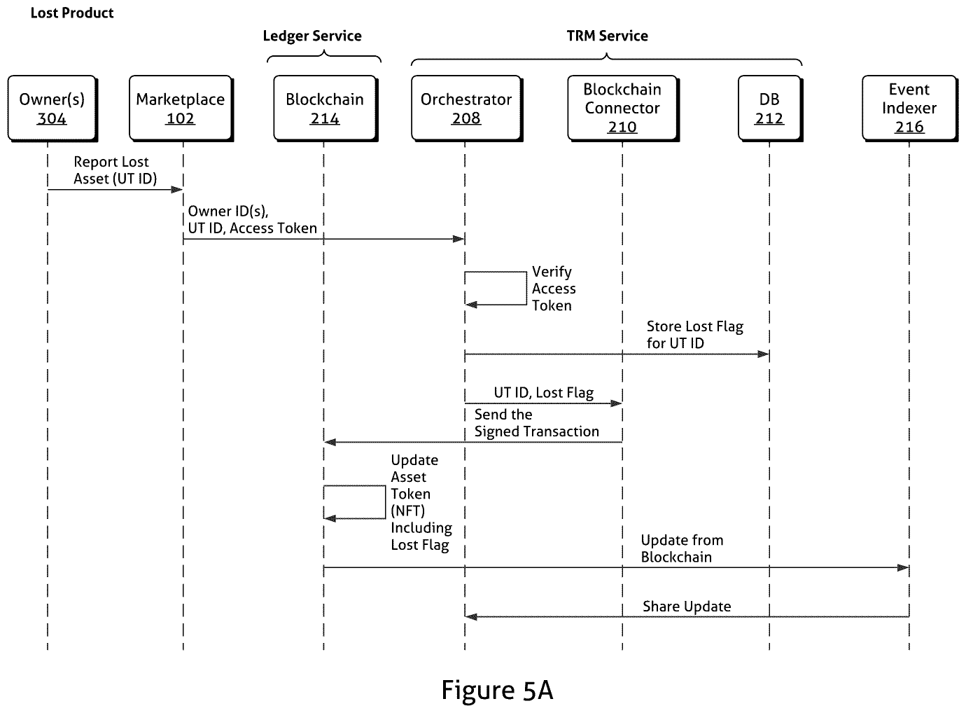

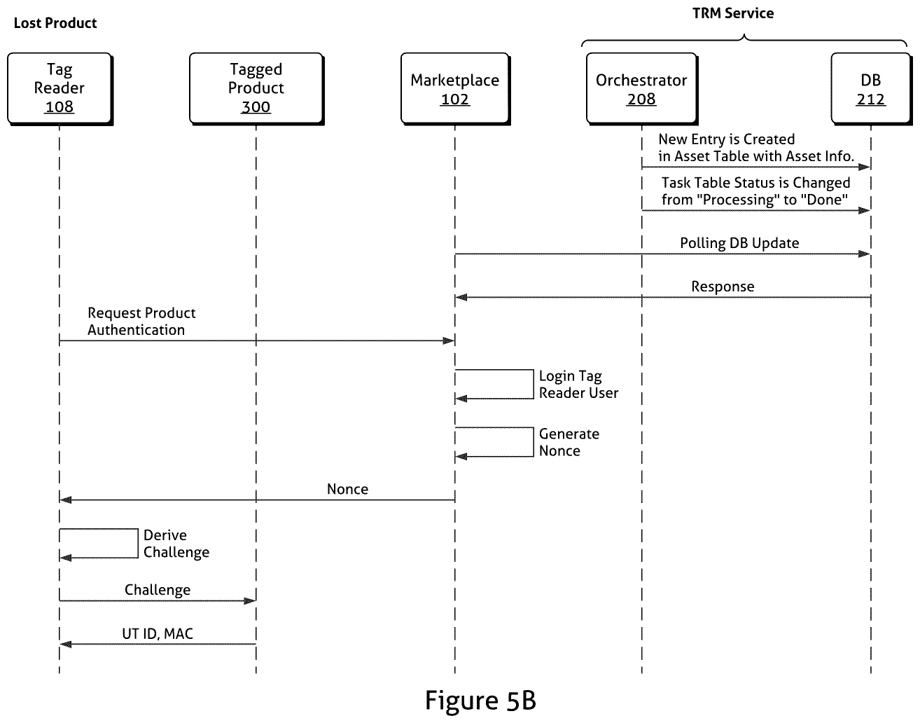

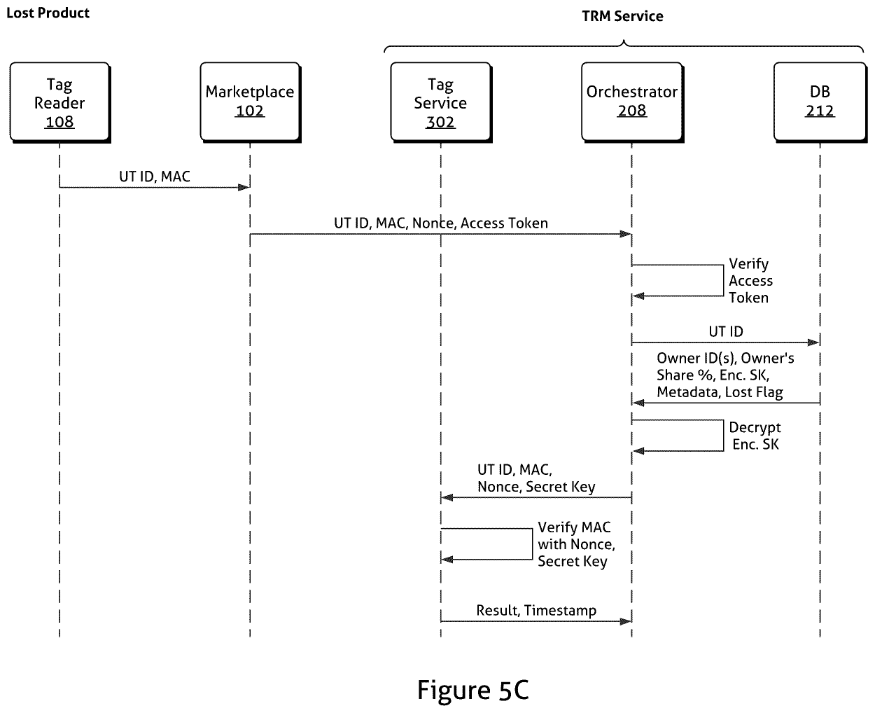

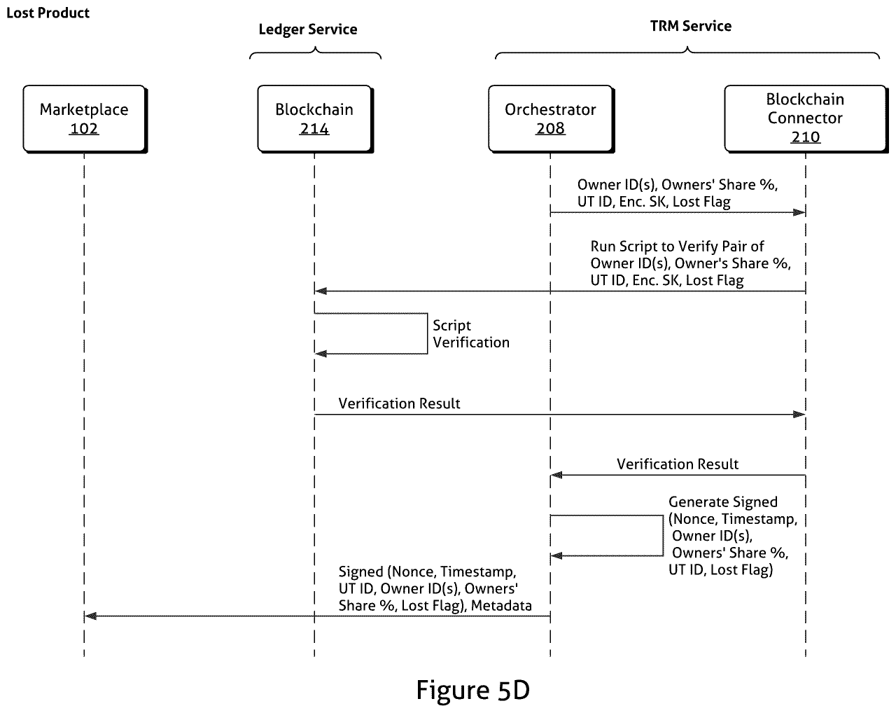

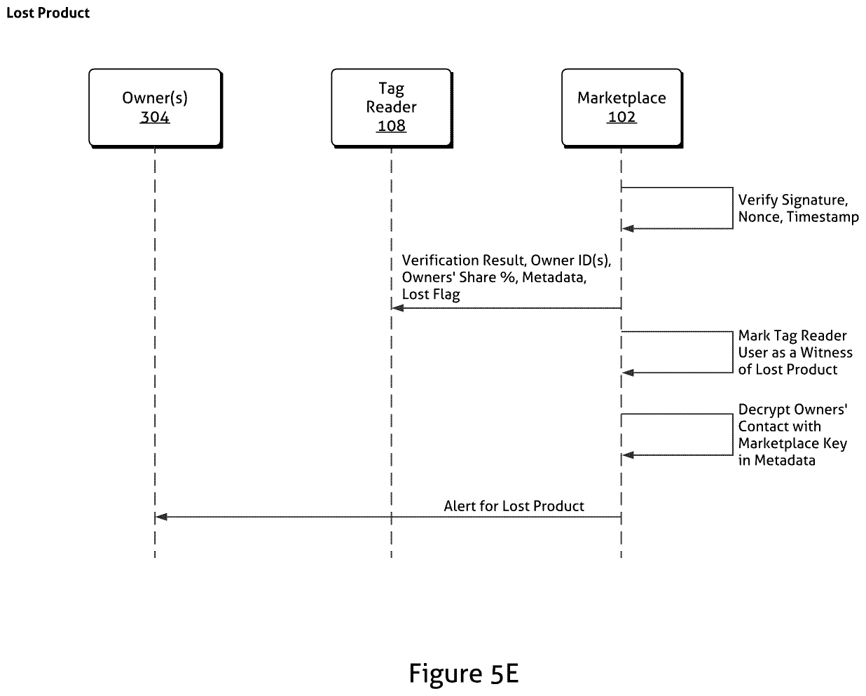

FIGS. 5A-5E illustrate conceptual diagrams showing non-limiting examples of various aspects of a process for managing lost and/or stolen assets consistent with certain embodiments disclosed herein. As illustrated, a product owner 304 may report their product as lost to a marketplace service 102. The marketplace service 102 may communicate associated owner identifier information, tag identifier information, and/or access token to an orchestrator service 208 of the TRM system for verification. If verified, the orchestrator service 208 may store within the DB 212 a flag indicating that the product associated with the tag identifier is lost. The orchestrator service 208 may further direct the blockchain connector service 210 to store a transaction associated with the tag identifier indicating the associated product as lost. The blockchain connector service 210 may send a signed transaction to a ledger service to update recorded asset token information in a managed blockchain 214 to reflect that the asset has been flagged as lost, potentially updating an event indexer service 216 which may share the update with the orchestrator service 208.

The orchestrator service 208 may further update an asset and/or product table managed by the DB 212 to reflect that the product has been marked as lost and/or stolen (e.g., by creating a new entry in the table). In addition, the status of recording the transaction associated with the loss and/or stolen product may be updated in task table which may manage the status of various transactions and/or operations performed by the TRM service and/or its constituent services (e.g., the orchestrator service 208). In various embodiments, the DB 212 of the TRM service may be queried for updates through periodic and/or event driven polling and/or querying by the marketplace service 102, which may receive an associated response.

As discussed above, a tag reader 108 may be used to authenticate a tag associated with a product marked as lost and/or stolen. A request may be issued by the tag reader 108 to authenticate a product with the marketplace service 102. In response to the request, potentially after a successful login process by the tag reader 108, the marketplace service 102 may generate a nonce and return it to the tag reader 108. Based on the received nonce, the tag reader 108 may generate and/or otherwise derive a challenge (e.g., a challenge value). The challenge may be issued by the tag reader 108 to the tag associated with the tagged product 300.

In response, the tag may return to the tag reader 108 the tag identifier and a MAC calculated by the tag based on the issued challenge and provisioned secret key. The tag reader 108 may communicate the returned tag identifier and MAC, to the marketplace service 102, which may be forwarded to the orchestrator service 208 of the TRM service along with the nonce generated by the marketplace service 102 and shared with the tag reader 108, and an access token (e.g., an access token provisioned to the marketplace service 102 by the TRM service).

The orchestrator service 208 may verify the access token. If the access token is verified, the orchestrator service 208 may query the DB 212 with the tag identifier and, in response, receive the identifiers(s) associated with product owner(s) 304 and/or rights holder(s), a percentage of ownership and/or associated rights held by the owner(s) 304 and/or rights holder(s) (e.g., a share % if applicable), the encrypted secret key, metadata stored by the DB 212 associated with the subject tag identifier, and/or the flag indicating the asset has been marked as lost and/or stolen. Using a decryption key, the orchestrator service 208 may decrypt the secret key returned from the DB 212 and provide the decrypted secret key to the tag service 302 along with the tag identifier, the MAC, and the nonce.

The tag service 302 may verify the MAC using the provided nonce and the decrypted secret key, returning a result to the orchestrator service 208 along with an associated timestamp. If verified by the tag service 302, the orchestrator service 208 may query the blockchain connector service with the tag identifier, the identifiers(s) associated with product owner(s) 304 and/or rights holder(s), the percentage of ownership and/or associated rights held by the owner(s) 304 and/or rights holder(s), the encrypted secret key, and the flag indicating the asset has been marked as lost and/or stolen. The blockchain connector service 210 may run a script to verify whether the blockchain 214 managed by the ledger service includes an entry corresponding to the tag identifier, the identifier(s) associated with product owner(s) 304 and/or rights holder(s), the percentage of ownership and/or associated rights held by the owner(s) 304 and/or rights holder(s), the encrypted secret key, and the flag. The ledger service may verify whether the entry is included in the blockchain 214, returning the result to the blockchain connector service 210 which may be shared with the orchestrator service 208.

The orchestrator service 208 may generate a signature based on one or more of the nonce, the timestamp returned from the tag service 302 (e.g., which may be used to check and/or otherwise verify freshness of the tag information managed by the tag service 302), the identifiers(s) associated with product owner(s) 304 and/or rights holder(s), the percentage of ownership and/or associated rights held by the owner(s) 304 and/or rights holder(s), the tag identifiers, and/or flag. The signature may be shared with the marketplace service 102 along with associated metadata.

The marketplace service 102 may verify one or more of the received signature, nonce, and/or timestamp. Based on the verification, the marketplace service 102 may provide the tag reader 108 with an indication of the verified identifiers(s) associated with product owner(s) 304 and/or rights holder(s) and/or the percentage of ownership and/or associated rights held by the owner(s) 304 and/or rights holder(s).

In various embodiments, the marketplace service 102 may further mark the user of the tag reader 108 as a witness of a lost and/or stolen product. In further embodiments, the product owner(s)′ contact information may be decrypted by the marketplace service 102, which may use the contact information to alert the product owner 304 of the attempt to authenticate the lost and/or stolen product.

### Tag Possession Verification

Certain embodiments disclosed herein may mitigate undesirable transactions where a user purchases a physical product and its associated token, sells the physical product to another individual, and then sells a knock-off product and the token to a further individual. Consistent with embodiments disclosed herein, the marketplace service may be configured to check for possession of a physical product associated with a token. For example, when listing a token associated with a physical product with the marketplace for sale, the marketplace service may check whether an owner of the token still owns the corresponding physical product.

In certain embodiments, if the marketplace service knows a unique tag identifier associated with a physical product, the marketplace service may verify its owner using a TRM system consistent with the disclosed systems and methods. If the marketplace knows an asset identifier (NFT: asset token ID) of the physical product, the marketplace service can verify its owner (recorded in NFT) by using TRM service as well. Once the marketplace knows an owner of the physical good, it can initiate a “Request Tag Possession Verification” process to the owner. Then, the owner may directly authenticate the unique tag, and the authentication result may be sent to the marketplace service so that it can confirm that the owner is located close enough to the unique tag.

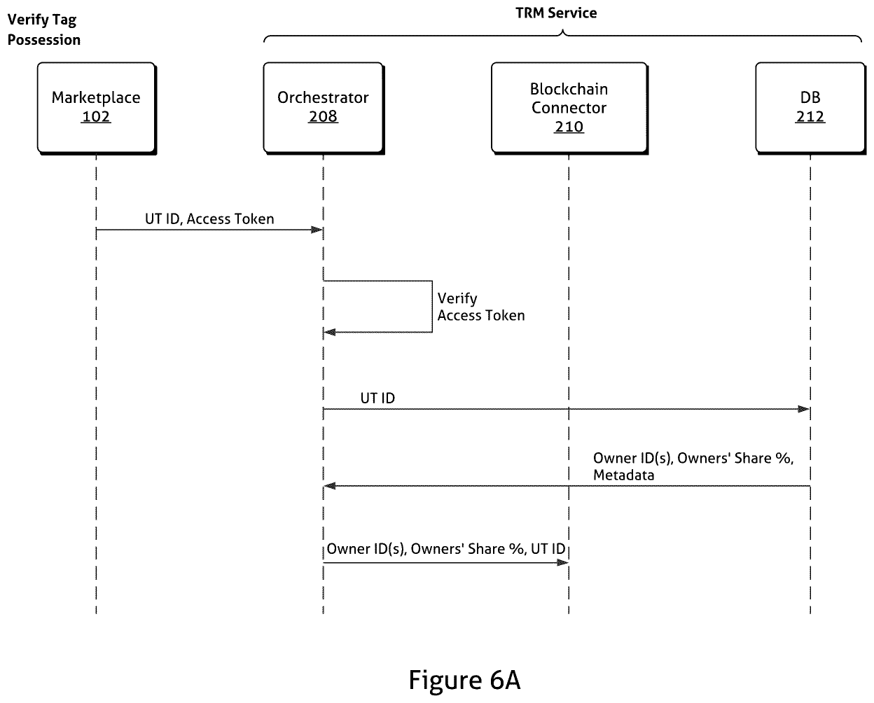

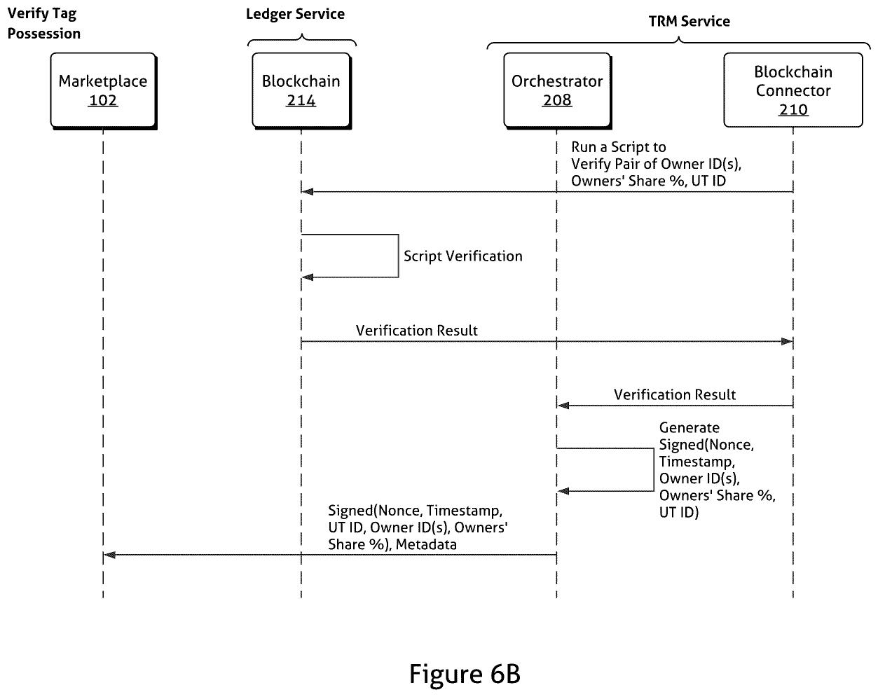

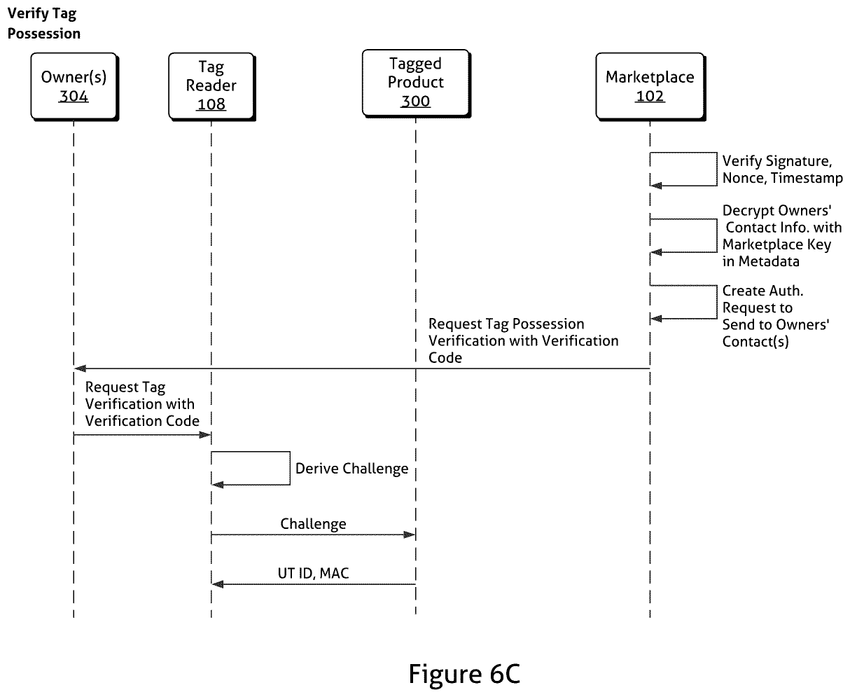

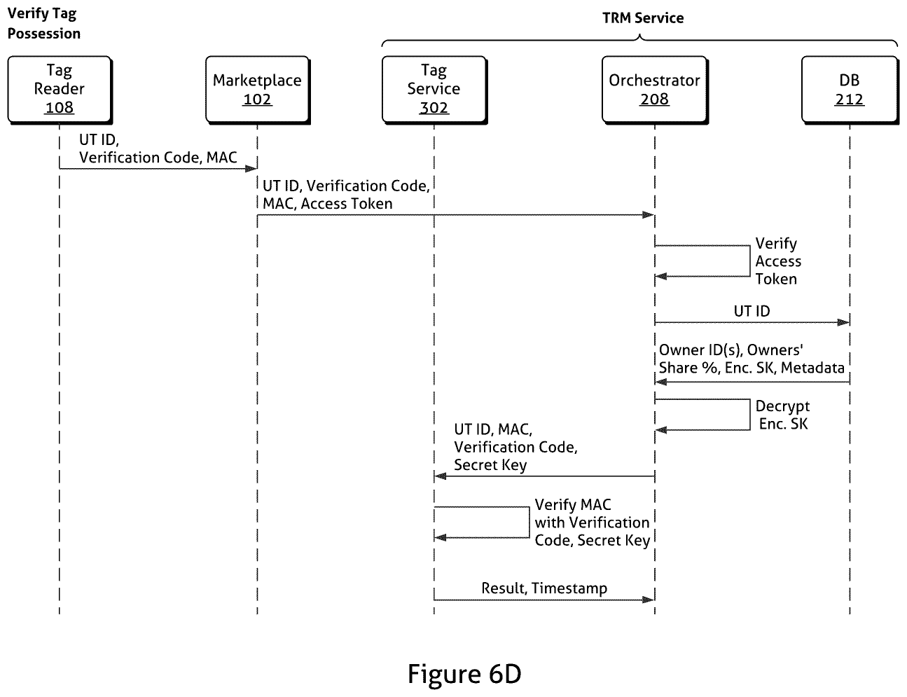

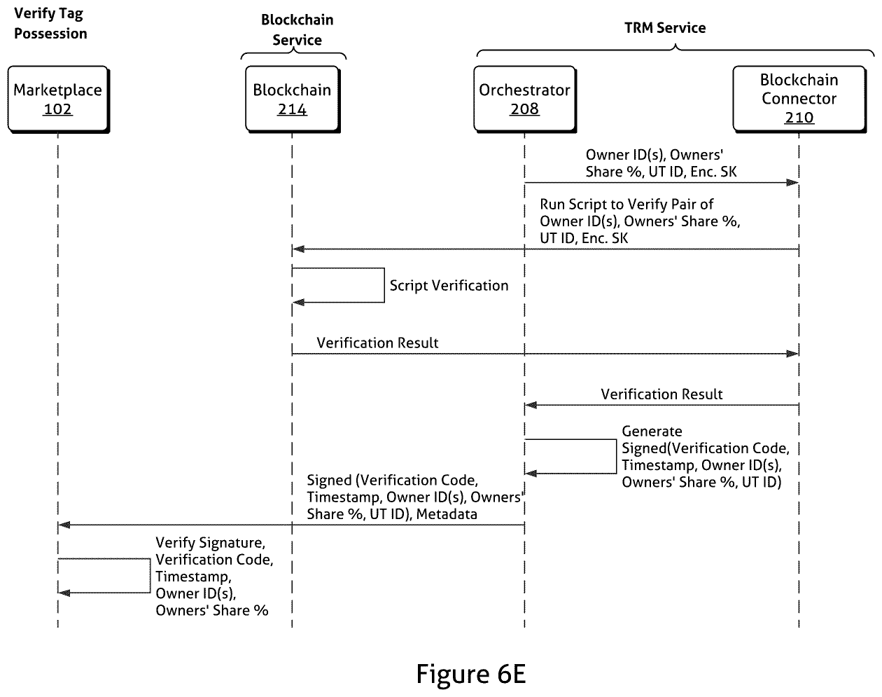

FIGS. 6A-6D illustrate conceptual diagrams showing non-limiting examples of various aspects of a tag possession verification process consistent with certain embodiments disclosed herein. The marketplace service 102 may forward a tag identifier and the access token to the orchestrator service 208 of the TRM service. The orchestrator service 208 may verify the access token. If the access token is verified, the orchestrator service 208 may query the DB 212 with the tag identifier and, in response, receive the identifier(s) associated with product owner(s) 304 and/or rights holder(s), a percentage of ownership and/or associated rights held by the owner(s) 304 and/or rights holder(s) (e.g., a share % if applicable), and/or metadata stored by the DB 212 associated with the subject tag identifier. The orchestrator service 208 may provide the blockchain connector service 210 with the identifiers(s) associated with product owner(s) 304 and/or rights holder(s), the percentage of ownership and/or associated rights held by the owner(s) 304 and/or rights holder(s) (e.g., a share % if applicable), and/or the tag identifier.

The blockchain connector service 210 may run a script to verify whether the blockchain 214 managed by the ledger service includes an entry corresponding to the tag identifier, the identifier(s) associated with product owner(s) 304 and/or rights holder(s), and the percentage of ownership and/or associated rights held by the owner(s) 304 and/or rights holder(s). The ledger service may verify whether the entry is included in the blockchain 214, returning the result to the blockchain connector service 210 which may be shared with the orchestrator service 208.

The orchestrator service 208 may generate a signature based on one or more of the nonce, the timestamp returned from the tag service 302 (e.g., which may be used to check and/or otherwise verify freshness of the tag information managed by the tag service 302), the identifiers(s) associated with product owner(s) 304 and/or rights holder(s), the percentage of ownership and/or associated rights held by the owner(s) 304 and/or rights holder(s), and/or the tag identifier. The signature may be shared with the marketplace service 102 along with associated metadata.

The marketplace service 102 may verify one or more of the received signature, nonce, and/or timestamp. If verified, the marketplace service 102 may decrypt contact information associated with the owner(s) 304 using a marketplace key included in the metadata. The marketplace service 102 may create an authentication request to send to the owners contact information, and the tag possession verification message may be sent to the owner 304 with a verification code (“VC”). The owner 304 may issue a tag verification request with the VC to the tag reader 108.

The tag reader 108 may generate and/or otherwise derive a challenge (e.g., a challenge value). The challenge may be issued by the tag reader 108 to the tag embedded in the tagged product 300. In response, the tag may return to the tag reader the tag identifier and a MAC calculated by the tag based on the issued challenge and a provisioned secret key.

The tag reader 108 may communicate the returned tag identifier, MAC, and VC to the marketplace service 102, which may share the information along with an access token with the orchestrator service 208 of the TRM service. The orchestrator service 208 may verify the access token. If the access token is verified, the orchestrator service 208 may query the DB 212 with the tag identifier and, in response, receive the identifiers(s) associated with product owner(s) 304 and/or rights holder(s), a percentage of ownership and/or associated rights held by the owner(s) 304 and/or rights holder(s) (e.g., a share % if applicable), the encrypted secret key, and/or metadata stored by the DB 212 associated with the subject tag identifier. Using a decryption key, the orchestrator service 208 may decrypt the secret key returned from the DB 212 and provide the decrypted secret key to the tag service 302 along with the tag identifier, MAC, and the VC.

The tag service 302 may verify the MAC using the provided VC and the decrypted secret key, returning a result to the orchestrator service 208 along with an associated timestamp. If verified by the tag service 302, the orchestrator service 208 may query the blockchain connector service 210 with the tag identifier, the identifier(s) associated with product owner(s) 304 and/or rights holder(s), the percentage of ownership and/or associated rights held by the owner(s) 304 and/or rights holder(s), and the encrypted secret key. The blockchain connector service 210 may run a script to verify whether the blockchain 214 managed by the ledger service includes an entry corresponding to the tag identifier, the identifier(s) associated with product owner(s) 304 and/or rights holder(s), the percentage of ownership and/or associated rights held by the owner(s) 304 and/or rights holder(s), and the encrypted secret key. The ledger service may verify whether the entry is included in the blockchain 214, returning the result to the blockchain connector service 210 which may be shared with the orchestrator service 208.

The orchestrator service 208 may generate a signature based on one or more of the VC, the timestamp returned from the tag service 302 (e.g., which may be used to check and/or otherwise verify freshness of the tag information managed by the tag service 302), the identifiers(s) associated with product owner(s) 304 and/or rights holder(s), the percentage of ownership and/or associated rights held by the owner(s) 304 and/or rights holder(s), and/or the tag identifier. The signature may be shared with the marketplace service 102 along with associated metadata.

The marketplace service 102 may verify one or more of the received signature, VC, timestamp, the identifiers(s) associated with product owner(s) and/or rights holder(s), and/or the percentage of ownership and/or associated rights held by the owner(s) and/or rights holder(s). Based on the verification, the marketplace service 102 may provide the tag reader 108 with an indication of the verified ID(s) associated with product owner(s) 304 and/or rights holder(s) and/or the percentage of ownership and/or associated rights held by the owner(s) 304 and/or rights holder(s).

### Management of Physical Products—Luxury Goods & Limited Release Items

As detailed above, embodiments of the disclosed systems and methods may be used to manage a variety of products and/or associated bundles of individual products including, for example and without limitation, shoes, handbags, vinyl records, luxury items, and/or any other type of physical product in a variety of contexts, use cases, and/or applications. For example and without limitation, using embodiments of the disclosed systems and methods, a unique shoe (which may be a unique design) may be embedded with an NFC and/or other secure tag. An NFT may be minted and securely associated with the secure tag, and ownership of the shoe, reproduction of the shoe design, validation of the shoe's authenticity, and/or the like, may be managed using various embodiments disclosed herein.

In another non-limiting example, a limited-edition vinyl record may be embedded with an NFC and/or other secure tag. An NFT may be minted and securely associated with the secure tag, and ownership, use, and/or authenticity of the vinyl record may be managed and/or validated in a trusted manner consistent with embodiments disclosed herein.

### Management of Physical Products—Product Inventory Management

Further embodiments of the present disclosure may be used in connection with managing physical products (and/or groups of physical products) as part of an inventory management system and/or associated processes. For example, in certain embodiments, individual and/or groups of products may be associated with secure tags and/or associated product identifiers. These tags and/or product identifiers may be associated with NFTs, providing a digital representation of the products that may be managed in accordance with various aspects of the disclosed systems and methods.

Lost and/or Stolen Product Management Example Use Case

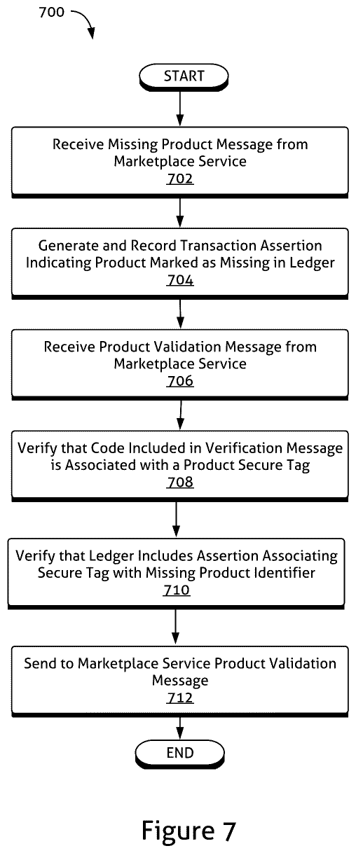

FIG. 7 illustrates a flow chart of a non-limiting example of a method 700 of managing a missing product consistent with certain embodiments of the present disclosure. The illustrated method 700 may be implemented in a variety of ways, including using software, firmware, hardware, and/or any combination thereof. In certain embodiments, various aspects of the method 700 and/or its constituent steps may be performed by a service, system, and/or device configured to implement embodiments of a TRM service (and/or associated services such as a marketplace service, blockchain connector service (which may be more generally described as a ledger connector service), a DB service, a tag service, and/or any other suitable application, device, system and/or service or combination of applications, devices, systems, and/or services.

At 702, the TRM service (e.g., and orchestrator service of a TRM service) may receive a missing product message from a marketplace service. In some embodiments, the missing product message may comprise an owner identifier, a secure tag identifier associated with a missing product (e.g., stolen and/or lost), and an indication that the product has been marked by an owner as missing. In some embodiments, the indication that product has been marked by an owner as missing may be represented by a data flag indication. In certain embodiments, the owner identifier, the secure tag identifier associated with the product, and the indication that the product has been marked by the owner as missing may be stored in a database managed by the TRM service.

A transaction assertion may be generated and recorded in a trusted ledger indicating that product has been marked as missing at 704. For example, in some embodiments, using a ledger connector service, which may be a service of the TRM service), a transaction assertion may be generated based, at least in part, on the secure tag identifier and the indication that the product has been marked as missing. The transaction assertion may be sent for recordation in a trusted ledger via a ledger connector service (e.g., a blockchain connector service), which may be a service of the TRM service). Consistent with embodiments disclosed herein, the trusted ledger may comprise a blockchain and/or another trusted immutable assertion ledger.

At 706, the TRM service may receive a product validation message from the marketplace service. For example, in various embodiments, a user may be interested in determining whether a particular product has been declared missing (e.g., lost and/or stolen) and/or may otherwise desire to validate the product. Consistent with embodiments disclosed herein, the product validation message may comprise the secure tag identifier, a nonce value, and a first code value, which in some embodiments may comprise a MAC value. The first code value may be generated by a secure tag (e.g., an NFC tag) associated with the product based, at least in part, on the nonce value, potentially received via a tag reader system.

In further embodiments, the product validation message may comprise an access token. For example, the message may comprise an access token associated with the marketplace service. In certain embodiments, the TRM service may validate the access token before processing the product validation message consistent with various aspects of the disclosed embodiments.

Using a tag service, which may be a service of the TRM service, it may be verified that first code value is associated with the secure tag identifier at 708. In some embodiments, verifying that the first code value is associated with the secure tag identifier may comprise retrieving a secret key from the database managed by the TRM associated with the secure tag identifier. The nonce value and the secret key may be sent to the tag service, which may generate a second code value based, at least in part, on the nonce value and the secret key. If the tag service determines that the first code value and the second code value match, it may be verified that the first code value is indeed associated with the secure tag identifier.

In some embodiments, the secret key may be encrypted in the database. The encrypted secret key may be retrieved from the database using the secure tag identifier and decrypted using a key associated with the TRM service. In some embodiments, the secret key may be uniquely associated with the secure tag identifier.

At 710, the TRM service may verify that the trusted ledger managed by the ledger service includes at least one recorded assertion associating the secure tag identifier with the indication that the product has been marked by the owner as missing. If verified, the TRM service The TRM service may send a message indicating that the product has been marked by the owner as missing to the marketplace service at 712, which may be communicated to user by the marketplace service.

System and/or Service Architecture

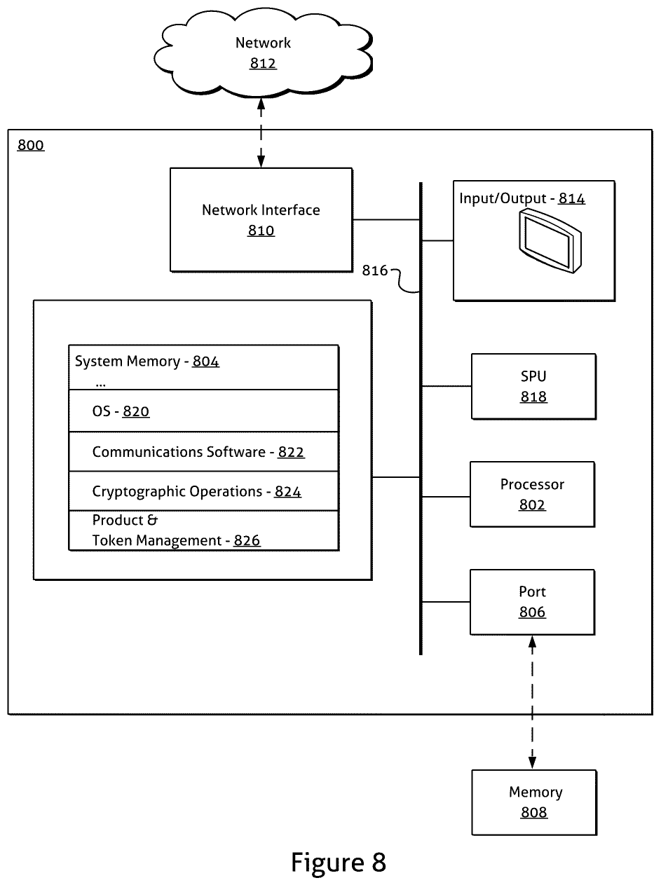

FIG. 8 illustrates a non-limiting example of a system 800 that may be used to implement certain embodiments of the systems and methods of the present disclosure. The system 800 of FIG. 8 and/or aspects thereof may be included in a system, service, and/or device associated with an owner, an ORH, a user, a marketplace service, a TRM service, a trusted data management platform service, a TIDAL and/or an associated ledger service, a DRM and/or KMS service, a DB, a file storage service, a payment gateway service, a wallet service, a blockchain service, a tag service, an orchestrator service, a content distribution service, an event indexer service, a blockchain connector service, and/or any other service, which may comprise a trusted service, system, and/or component configured to implement embodiments of the disclosed systems and methods and/or aspects thereof.

The various systems and/or devices used in connection with aspects the disclosed embodiments may be communicatively coupled using a variety of networks and/or network connections (e.g., network 812). In certain embodiments, the network 812 may comprise a variety of network communication devices and/or channels and may utilize any suitable communications protocols and/or standards facilitating communication between the systems and/or devices. The network 812 may comprise the Internet, a local area network, a virtual private network, and/or any other communication network utilizing one or more electronic communication technologies and/or standards (e.g., Ethernet or the like). In some embodiments, the network 812 may comprise a wireless carrier system such as a personal communications system (“PCS”), and/or any other suitable communication system incorporating any suitable communication standards and/or protocols. In further embodiments, the network 812 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network 812 may incorporate one or more satellite communication links. In yet further embodiments, the network 812 may utilize IEEE's 802.11 standards, Bluetooth®, ultra-wide band (“UWB”), Zigbee®, and or any other suitable standard or standards.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. As discussed in more detail below, systems used in connection with implementing various aspects of the disclosed embodiments may further comprise a secure processing unit (“SPU”) configured to perform sensitive operations such as trusted credential and/or key management, cryptographic operations, secure policy management, and/or other aspects of the systems and methods disclosed herein. The systems and/or devices may further comprise software and/or hardware configured to enable electronic communication of information between the devices and/or systems via a network using any suitable communication technology and/or standard.

As illustrated in FIG. 8, the example system 800 may comprise: a processing unit 802; system memory 804, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 802; a port 806 for interfacing with removable memory 608 that may include one or more diskettes, optical storage mediums (e.g., flash memory, thumb drives, USB dongles, compact discs, DVDs, etc.) and/or other non-transitory computer-readable storage mediums; a network interface 810 for communicating with other systems via one or more network connections and/or networks 812 using one or more communication technologies; a user interface 814 that may include a display and/or one or more input/output devices such as, for example, a touchscreen, a keyboard, a mouse, a track pad, and the like; and one or more busses 816 for communicatively coupling the elements of the system.

In some embodiments, the system 800 may, alternatively or in addition, include a trusted execution environment and/or an SPU 818 that is protected from tampering by a user of the system or other entities by utilizing secure physical and/or virtual security techniques. A trusted execution environment and/or a SPU 818 can help enhance the security of sensitive operations such as personal information management, trusted credential, token, and/or key management, privacy and policy management, and other aspects of the systems and methods disclosed herein. In certain embodiments, the trusted execution environment and/or SPU 818 may operate in a logically secure processing domain and be configured to protect and operate on secret information, as described herein. In some embodiments, the trusted execution environment and/or a SPU 818 may include internal memory storing executable instructions or programs configured to enable the SPU 818 to perform secure operations, as described herein.

The operation of the system 800 may be generally controlled by the processing unit 802 and/or an SPU 818 operating by executing software instructions and programs stored in the system memory 804 (and/or other computer-readable media, such as memory 808, which may be removable). The system memory 804 may store a variety of executable programs or modules for controlling the operation of the system. For example, the system memory may include an operating system (“OS”) 820 that may manage and coordinate, at least in part, and/or system hardware resources and provide for common services for execution of various applications.

The system memory 804 may further include, without limitation, communication software 822 configured to enable in part communication with and by the system, one or more applications, a cryptographic operation module 824 configured to perform various aspects of the disclosed embodiments (e.g., cryptographic key and hash generation operations, key management operations, etc.), one or more product and/or token management modules 826 configured to perform various aspects of the methods disclosed herein, and/or any other information, modules, and/or applications configured to implement embodiments of the systems and methods disclosed herein.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein but may be modified with the scope and equivalents of the appended claims.

The invention claimed is:

1. A method for managing missing products performed by a token rights management service executing on a system comprising a processor and a non-transitory computer-readable storage medium storing instructions that, when executed by the processor, cause the system to perform the method, the method comprising:
receiving, from a marketplace service, a missing product message, the missing product message comprising an owner identifier, a secure tag identifier associated with a product, and an indication that the product has been marked by an owner as missing;
generating, using a ledger connector service, a transaction assertion, the transaction assertion being generated based on the secure tag identifier and the indication that the product has been marked as missing;
sending, via the ledger connector service, the transaction assertion to a ledger service for recordation in a trusted ledger managed by the ledger service;
receiving, from the marketplace service, a product validation message, the product validation message comprising the secure tag identifier, a nonce value, and a first code value, the first code value being generated by a secure tag associated with the product based, at least in part, on the nonce value;
verifying, using a tag service, that the first code value is associated with the secure tag identifier;
determining, using the ledger connection service, that the trusted ledger managed by the ledger service includes at least one recorded assertion associating the secure tag identifier with the indication that the product has been marked by the owner as missing;
sending, to the marketplace service in response to the product validation message, a message indicating that the product has been marked by the owner as missing.

2. The method of claim 1, wherein the indication that the product has been marked as missing comprises one or more of an indication that the product has been marked as lost and an indication that the product has been marked as stolen.

3. The method of claim 2, wherein the indication that the product has been marked as missing comprises a data flag indication.

4. The method of claim 1, wherein the first code value comprises a message authentication code value.

5. The method of claim 1, wherein the method further comprises storing the owner identifier, the secure tag identifier associated with the product, and the indication that the product has been marked by an owner as missing in a database managed by the token rights management service.

6. The method of claim 5, wherein verifying that the first code value is associated with the secure tag identifier comprises:
retrieving a secret key from a database managed by the token rights management service associated with the secure tag identifier;
sending, to the tag service, the nonce value and the secret key;
generating, by the tag service, a second code value based, at least in part, on the nonce value and the secret key; and
determining, by the tag service, that the first code value and the second code value match.

7. The method of claim 6, wherein retrieving the secret key comprises retrieving the secret key using the secure tag identifier.

8. The method of claim 7, wherein retrieving the secret key comprises:
requesting the secret key from the database using the secure tag identifier;
receiving an encrypted secret key from the database associated with the secure tag identifier in response to the request; and
decrypting the encrypted secret key using a key associated with the token rights management service.

9. The method of claim 1, wherein the secret key is uniquely associated with the secure tag identifier.

10. The method of claim 1, wherein the tag service comprises a service of the token rights management service.

11. The method of claim 1, wherein the ledger connector service comprises a service of the token rights management service.

12. The method of claim 1, wherein the trusted ledger comprises a blockchain ledger.

13. The method of claim 1, wherein the trusted ledger comprises a trusted immutable distributed assertion ledger.

14. The method of claim 1, wherein the first code value is received from the secure tag by a tag reader system in communication with the marketplace service.

15. The method of claim 1, wherein the product validation message further comprises an access token.

16. The method of claim 1, wherein the method further comprises validating, by the token rights management service, the access token.

17. The method of claim 1, wherein the secure tag comprises a near field communication tag.
